(19) United States
(12) Patent Application Publication
(10) Pub. No.: US 2025/0175221 A1
(43) Pub. Date: May 29, 2025

(54) TECHNIQUES FOR REPORTING QUASI CO LOCATION INFORMATION

(71) Applicant: QUALCOMM INCORPORATED, San Diego, CA (US)

(72) Inventors: Qiaoyu Li, Beijing (CN); Mahmoud Taherzadeh Boroujeni, San Diego, CA (US); Tao Luo, San Diego, CA (US)

(21) Appl. No.: 18/840,046

(22) PCT Filed: Apr. 20, 2022
(86) PCT No.: PCT/CN2022/087906

§ 371 Date: Aug. 20, 2024

(51) Int. Cl. H04B 7/0456; H04B 17/309; H04L 5/00

(52) U.S. Cl. CPC H04B 7/0456; H04B 17/309; H04L 5/005

(57) ABSTRACT

Methods, systems, and devices for wireless communication are described. A user equipment (UE) may receive and measure channel state information reference signals (CSI-RS) and synchronization signal blocks (SSB) from a network entity via a reference signal resource set. The UE may select reference signal resources from the reference signal resource set based on channel measurements associated with the selected reference signal resources. The UE may determine a downlink precoding matrix based on quasi-co-location (QCL) information associated with a reference signal resource. In some examples, the UE may receive an indication of the QCL information from the network entity. Accordingly, the UE may transmit a report indicating both the downlink precoding matrix and the reference signal resource associated with the QCL information. Upon receiving the report from the UE, the network entity may output one or more downlink messages using the downlink precoding matrix indicated by the report.

### CROSS REFERENCE

The present application is a 371 national stage filing of International PCT Application No. PCT/CN2022/087906 by Li et al. entitled “TECHNIQUES FOR REPORTING QUASI CO LOCATION INFORMATION,” filed Apr. 20, 2022, which is assigned to the assignee hereof, and which is expressly incorporated by reference in its entirety herein.

### FIELD OF TECHNOLOGY

The following relates to wireless communication, including techniques for reporting quasi-co-location (QCL) information.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications system, a UE may provide a network entity with downlink precoding information. However, the network entity may be unable to use (e.g., apply) the downlink precoding information for subsequent communications without additional spatial information from the UE.

### SUMMARY

The described techniques relate to improved methods, systems, devices, and apparatuses that support techniques for reporting quasi-co-location (QCL) information. For example, the described techniques provide for configuring a user equipment (UE) to include QCL information for a downlink precoding matrix in a channel state information (CSI) report. In some examples, the UE may select resources from a resource set based on channel measurements associated with the selected resources. The UE may determine a downlink precoding matrix based on QCL information associated with a reference resource, which may be the same or different from the resources in the resource set. The downlink precoding matrix may include a combination of the selected resources. Accordingly, the UE may transmit a report that indicates the downlink precoding matrix and the reference resource associated with the QCL information.

A method for wireless communication at a UE is described. The method may include selecting reference signal resources from a reference signal resource set based on channel measurements associated with the selected reference signal resources, determining a downlink precoding matrix based on QCL information associated with a reference signal resource, where the downlink precoding matrix includes a combination of the selected reference signal resources, and transmitting a report that indicates the downlink precoding matrix and the reference signal resource associated with the QCL information.

An apparatus for wireless communication at a UE is described. The apparatus may include a processor and a memory coupled with the processor, with instructions stored in the memory, the instructions being executable by the processor to cause the apparatus to select reference signal resources from a reference signal resource set based on channel measurements associated with the selected reference signal resources, determine a downlink precoding matrix based on QCL information associated with a reference signal resource, where the downlink precoding matrix includes a combination of the selected reference signal resources, and transmit a report that indicates the downlink precoding matrix and the reference signal resource associated with the QCL information.

Another apparatus for wireless communication at a UE is described. The apparatus may include means for selecting reference signal resources from a reference signal resource set based on channel measurements associated with the selected reference signal resources, means for determining a downlink precoding matrix based on QCL information associated with a reference signal resource, where the downlink precoding matrix includes a combination of the selected reference signal resources, and means for transmitting a report that indicates the downlink precoding matrix and the reference signal resource associated with the QCL information.

A non-transitory computer-readable medium storing code for wireless communication at a UE is described. The code may include instructions executable by a processor to select reference signal resources from a reference signal resource set based on channel measurements associated with the selected reference signal resources, determine a downlink precoding matrix based on QCL information associated with a reference signal resource, where the downlink precoding matrix includes a combination of the selected reference signal resources, and transmit a report that indicates the downlink precoding matrix and the reference signal resource associated with the QCL information.

In some examples of the method, apparatuses, and non-transitory computer-readable medium described herein, the reference signal resource associated with the QCL information may be included in the reference signal resource set.

In some examples of the method, apparatuses, and non-transitory computer-readable medium described herein, the reference signal resource associated with the QCL information may be different from reference signal resources in the reference signal resource set.

Some examples of the method, apparatuses, and non-transitory computer-readable medium described herein may further include operations, features, means, or instructions for receiving control signaling indicating one or more reference signal resources that can be used to determine the downlink precoding matrix, where the one or more reference signal resources include the reference signal resource associated with the QCL information.

In some examples of the method, apparatuses, and non-transitory computer-readable medium described herein, transmitting the report may include operations, features, means, or instructions for transmitting a CSI report that indicates the selected reference signal resources, a set of linear combination coefficients associated with the selected reference signal resources, a reference signal received power (RSRP) associated with the downlink precoding matrix, a signal to interference and noise ratio (SINR) associated with the downlink precoding matrix, or any combination thereof.

In some examples of the method, apparatuses, and non-transitory computer-readable medium described herein, the selected reference signal resources include the reference signal resource associated with the QCL information.

In some examples of the method, apparatuses, and non-transitory computer-readable medium described herein, the reference signal resource associated with the QCL information includes a reference signal resource with a highest RSRP or a highest SINR in the selected reference signal resources.

Some examples of the method, apparatuses, and non-transitory computer-readable medium described herein may further include operations, features, means, or instructions for identifying a QCL relationship between one of the selected reference signal resources and the reference signal resource associated with the QCL information.

Some examples of the method, apparatuses, and non-transitory computer-readable medium described herein may further include operations, features, means, or instructions for identifying a QCL relationship between the reference signal resource associated with the QCL information and a reference signal resource having a highest RSRP or a highest SINR in the selected reference signal resources.

In some examples of the method, apparatuses, and non-transitory computer-readable medium described herein, selecting the reference signal resources may include operations, features, means, or instructions for selecting CSI reference signal (CSI-RS) resources from a CSI-RS resource set and selecting CSI-RS ports for the selected CSI-RS resources.

In some examples of the method, apparatuses, and non-transitory computer-readable medium described herein, transmitting the report may include operations, features, means, or instructions for transmitting a CSI report that indicates the selected CSI-RS resources, the selected CSI-RS ports, a set of quantized linear combination coefficients associated with the selected CSI-RS resources and the selected CSI-RS ports, or any combination thereof.

In some examples of the method, apparatuses, and non-transitory computer-readable medium described herein, the reference signal resource associated with the QCL information includes a CSI-RS resource from the selected CSI-RS resources or a CSI-RS resource that is QCL-ed with at least one of the selected CSI-RS resources.

In some examples of the method, apparatuses, and non-transitory computer-readable medium described herein, the reference signal resource associated with the QCL information includes a CSI-RS resource with a highest RSRP or a highest SINR in the selected CSI-RS resources.

In some examples of the method, apparatuses, and non-transitory computer-readable medium described herein, the reference signal resource associated with the QCL information includes a multi-port CSI-RS resource with a highest RSRP or a highest SINR in the selected CSI-RS resources and the highest RSRP corresponds to an average RSRP across CSI-RS ports associated with the multi-port CSI-RS resource or a total RSRP across CSI-RS ports associated with the multi-port CSI-RS resource.

Some examples of the method, apparatuses, and non-transitory computer-readable medium described herein may further include operations, features, means, or instructions for identifying a QCL relationship between the reference signal resource associated with the QCL information and a CSI-RS resource having a highest RSRP or a highest SINR in the selected CSI-RS resources.

Some examples of the method, apparatuses, and non-transitory computer-readable medium described herein may further include operations, features, means, or instructions for determining a beam point direction for downlink precoding based on channel measurements associated with the reference signal resource set, where the determined beam point direction is defined by an azimuth angle and an elevation angle.

In some examples of the method, apparatuses, and non-transitory computer-readable medium described herein, transmitting the report may include operations, features, means, or instructions for transmitting a CSI report that indicates the determined beam point direction, a RSRP associated with the determined beam point direction, a SINR associated with the determined beam point direction, or any combination thereof.

Some examples of the method, apparatuses, and non-transitory computer-readable medium described herein may further include operations, features, means, or instructions for receiving an indication of a mapping between beam point directions and reference signal resources in the reference signal resource set and selecting a reference signal resource from the reference signal resource set based on a beam point direction of the selected reference signal resource having a closest proximity to the determined beam point direction, where the reference signal resource associated with the QCL information includes the selected reference signal resource.

Some examples of the method, apparatuses, and non-transitory computer-readable medium described herein may further include operations, features, means, or instructions for receiving an indication of a mapping between beam point directions and reference signal resources in the reference signal resource set, identifying two or more reference signal resources in the reference signal resource set that satisfy a proximity threshold with respect to the determined beam point direction, and selecting a reference signal resource from the identified two or more reference signal resources based on a reference signal resource identifier associated with the selected reference signal resource, an azimuth angle proximity of the selected reference signal resource, an elevation angle proximity of the selected reference signal resource, or any combination thereof, where the reference signal resource associated with the QCL information includes the selected reference signal resource.

Some examples of the method, apparatuses, and non-transitory computer-readable medium described herein may further include operations, features, means, or instructions for receiving control signaling indicating a mapping between beam point directions and a set of downlink reference signal resources that are different from reference signal resources in the reference signal resource set and selecting a downlink reference signal resource from the set of downlink reference signal resources based on a beam point direction of the selected downlink reference signal resource having a closest proximity to the determined beam point direction, where the reference signal resource associated with the QCL information includes the selected downlink reference signal resource.

Some examples of the method, apparatuses, and non-transitory computer-readable medium described herein may further include operations, features, means, or instructions for receiving control signaling indicating a mapping between beam point directions and a set of downlink reference signal resources that are different from reference signal resources in the reference signal resource set, identifying two or more downlink reference signal resources in the set of downlink reference signal resources that satisfy a proximity threshold with respect to the determined beam point direction, prioritizing the two or more downlink reference signal resources with respect to resource type, resource identifier, azimuth angle proximity, elevation angle proximity, or any combination thereof, and selecting a downlink reference signal resource from the prioritized two or more downlink reference signal resources, where the reference signal resource associated with the QCL information includes the selected downlink reference signal resource.

A method for wireless communication at a network entity is described. The method may include outputting one or more reference signals via a reference signal resource set, obtaining a report that indicates a downlink precoding matrix and a reference signal resource associated with QCL information used to determine the downlink precoding matrix, where the downlink precoding matrix includes a combination of reference signal resources from the reference signal resource set, and outputting one or more downlink messages using the downlink precoding matrix indicated by the report.

An apparatus for wireless communication at a network entity is described. The apparatus may include a processor and a memory coupled with the processor, with instructions stored in the memory, the instructions being executable by the processor to cause the apparatus to output one or more reference signals via a reference signal resource set, obtain a report that indicates a downlink precoding matrix and a reference signal resource associated with QCL information used to determine the downlink precoding matrix, where the downlink precoding matrix includes a combination of reference signal resources from the reference signal resource set, and output one or more downlink messages using the downlink precoding matrix indicated by the report.

Another apparatus for wireless communication at a network entity is described. The apparatus may include means for outputting one or more reference signals via a reference signal resource set, means for obtaining a report that indicates a downlink precoding matrix and a reference signal resource associated with QCL information used to determine the downlink precoding matrix, where the downlink precoding matrix includes a combination of reference signal resources from the reference signal resource set, and means for outputting one or more downlink messages using the downlink precoding matrix indicated by the report.

A non-transitory computer-readable medium storing code for wireless communication at a network entity is described. The code may include instructions executable by a processor to output one or more reference signals via a reference signal resource set, obtain a report that indicates a downlink precoding matrix and a reference signal resource associated with QCL information used to determine the downlink precoding matrix, where the downlink precoding matrix includes a combination of reference signal resources from the reference signal resource set, and output one or more downlink messages using the downlink precoding matrix indicated by the report.

A method for wireless communication at a UE is described. The method may include receiving control signaling indicating QCL information associated with a reference signal resource, selecting reference signal resources from a reference signal resource set based on channel measurements associated with the selected reference signal resources, determining a downlink precoding matrix based on the QCL information, where the downlink precoding matrix includes a combination of the selected reference signal resources, and transmitting a report that indicates the downlink precoding matrix.

An apparatus for wireless communication at a UE is described. The apparatus may include a processor and a memory coupled with the processor, with instructions stored in the memory, the instructions being executable by the processor to cause the apparatus to receive control signaling indicating QCL information associated with a reference signal resource, select reference signal resources from a reference signal resource set based on channel measurements associated with the selected reference signal resources, determine a downlink precoding matrix based on the QCL information, where the downlink precoding matrix includes a combination of the selected reference signal resources, and transmit a report that indicates the downlink precoding matrix.

Another apparatus for wireless communication at a UE is described. The apparatus may include means for receiving control signaling indicating QCL information associated with a reference signal resource, means for selecting reference signal resources from a reference signal resource set based on channel measurements associated with the selected reference signal resources, means for determining a downlink precoding matrix based on the QCL information, where the downlink precoding matrix includes a combination of the selected reference signal resources, and means for transmitting a report that indicates the downlink precoding matrix.

A non-transitory computer-readable medium storing code for wireless communication at a UE is described. The code may include instructions executable by a processor to receive control signaling indicating QCL information associated with a reference signal resource, select reference signal resources from a reference signal resource set based on channel measurements associated with the selected reference signal resources, determine a downlink precoding matrix based on the QCL information, where the downlink precoding matrix includes a combination of the selected reference signal resources, and transmit a report that indicates the downlink precoding matrix.

In some examples of the method, apparatuses, and non-transitory computer-readable medium described herein, receiving the control signaling may include operations, features, means, or instructions for receiving downlink control information that indicates a CSI triggering state identifier associated with the reference signal resource to use for the QCL information.

In some examples of the method, apparatuses, and non-transitory computer-readable medium described herein, transmitting the report may include operations, features, means, or instructions for transmitting a CSI report that indicates the selected reference signal resources, quantized linear combination coefficients associated with the selected reference signal resources, a RSRP associated with the downlink precoding matrix, a SINR associated with the downlink precoding matrix, or any combination thereof.

In some examples of the method, apparatuses, and non-transitory computer-readable medium described herein, selecting the reference signal resources may include operations, features, means, or instructions for selecting CSI-RS resources from a CSI-RS resource set and selecting CSI-RS ports for the selected CSI-RS resources.

In some examples of the method, apparatuses, and non-transitory computer-readable medium described herein, transmitting the report may include operations, features, means, or instructions for transmitting a CSI report that indicates the selected CSI-RS resources, the selected CSI-RS ports, a set of quantized linear combination coefficients associated with the selected CSI-RS resources and the selected CSI-RS ports, a RSRP associated with the downlink precoding matrix, a SINR associated with the downlink precoding matrix, or any combination thereof.

Some examples of the method, apparatuses, and non-transitory computer-readable medium described herein may further include operations, features, means, or instructions for determining a beam point direction for downlink precoding based on channel measurements associated with the reference signal resource set, where the determined beam point direction is defined by an azimuth angle and an elevation angle.

In some examples of the method, apparatuses, and non-transitory computer-readable medium described herein, transmitting the report may include operations, features, means, or instructions for transmitting a CSI report that indicates the determined beam point direction, a RSRP associated with the determined beam point direction, a SINR associated with the determined beam point direction, or any combination thereof.

A method for wireless communication at a network entity is described. The method may include outputting control signaling indicating QCL information associated with a reference signal resource, outputting one or more reference signals via a reference signal resource set, obtaining an indication of a downlink precoding matrix that is based on the QCL information, where the downlink precoding matrix includes a combination of reference signal resources from the reference signal resource set, and outputting one or more downlink messages using the downlink precoding matrix.

An apparatus for wireless communication at a network entity is described. The apparatus may include a processor and a memory coupled with the processor, with instructions stored in the memory, the instructions being executable by the processor to cause the apparatus to output control signaling indicating QCL information associated with a reference signal resource, output one or more reference signals via a reference signal resource set, obtain an indication of a downlink precoding matrix that is based on the QCL information, where the downlink precoding matrix includes a combination of reference signal resources from the reference signal resource set, and output one or more downlink messages using the downlink precoding matrix.

Another apparatus for wireless communication at a network entity is described. The apparatus may include means for outputting control signaling indicating QCL information associated with a reference signal resource, means for outputting one or more reference signals via a reference signal resource set, means for obtaining an indication of a downlink precoding matrix that is based on the QCL information, where the downlink precoding matrix includes a combination of reference signal resources from the reference signal resource set, and means for outputting one or more downlink messages using the downlink precoding matrix.

A non-transitory computer-readable medium storing code for wireless communication at a network entity is described. The code may include instructions executable by a processor to output control signaling indicating QCL information associated with a reference signal resource, output one or more reference signals via a reference signal resource set, obtain an indication of a downlink precoding matrix that is based on the QCL information, where the downlink precoding matrix includes a combination of reference signal resources from the reference signal resource set, and output one or more downlink messages using the downlink precoding matrix.

### BRIEF DESCRIPTION OF THE DRAWINGS

FIG. 1 illustrates an example of a wireless communications system that supports techniques for reporting quasi-co-location (QCL) information in accordance with one or more aspects of the present disclosure.

FIGS. 2A and 2B illustrate examples of wireless communications systems that support techniques for reporting QCL information in accordance with one or more aspects of the present disclosure.

FIG. 3 illustrates an example of a resource diagram that supports techniques for reporting QCL information in accordance with one or more aspects of the present disclosure.

FIG. 4 illustrates an example of a process flow that supports techniques for reporting QCL information in accordance with one or more aspects of the present disclosure.

FIG. 5 illustrates an example of a process flow that supports techniques for reporting QCL information in accordance with one or more aspects of the present disclosure.

FIGS. 6 and 7 show block diagrams of devices that support techniques for reporting QCL information in accordance with one or more aspects of the present disclosure.

FIG. 8 shows a block diagram of a communications manager that supports techniques for reporting QCL information in accordance with one or more aspects of the present disclosure.

FIG. 9 shows a diagram of a system including a device that supports techniques for reporting QCL information in accordance with one or more aspects of the present disclosure.

FIGS. 10 and 11 show block diagrams of devices that support techniques for reporting QCL information in accordance with one or more aspects of the present disclosure.

FIG. 12 shows a block diagram of a communications manager that supports techniques for reporting QCL information in accordance with one or more aspects of the present disclosure.

FIG. 13 shows a diagram of a system including a device that supports techniques for reporting QCL information in accordance with one or more aspects of the present disclosure.

FIGS. 14 through 17 show flowcharts illustrating methods that support techniques for reporting QCL information in accordance with one or more aspects of the present disclosure.

### DETAILED DESCRIPTION

In some wireless communication systems, a network entity may transmit various channel state information reference signals (CSI-RS) and synchronization signal blocks (SSB) using different CSI-RS or SSB resources that correspond to different communication beams. A user equipment (UE) may receive the CSI-RSs and SSBs from the network entity and select one or more CSI-RS or SSB resources that are associated with favorable channel conditions (e.g., higher signal quality, lower interference). In some cases, the UE may use artificial intelligence (AI) or machine learning (ML) algorithms to implicitly determine (e.g., predict) a linear combination of CSI-RS or SSB resources that will have favorable channel conditions in a subsequent time period.

The UE may include the linear combination of selected CSI-RS or SSB resources in a downlink precoding matrix, and may transmit an indication of the downlink precoding matrix to the network entity. In some cases, however, the UE may determine the downlink precoding matrix by assuming a specific quasi-co-location (QCL) relationship between a reference signal resource and a receive beam of the UE. The network entity may be unable to accurately interpret the downlink precoding matrix provided by the UE without this QCL information.

In accordance with aspects of the present disclosure, the UE may provide the network entity with the downlink precoding matrix and the underlying QCL information used to determine the downlink precoding matrix. For example, if the UE determines the downlink precoding matrix by assuming a QCL relationship between a CSI-RS resource and a receive beam, the UE may transmit an indication of the CSI-RS resource to the network entity. In some examples, the reference signal resource used in the underlying QCL assumption may be one of the CSI-RS or SSB resources from the linear combination of CSI-RS or SSB resources in the downlink precoding matrix. In other examples, the reference signal resource used in the underlying QCL assumption may be a different resource that is specified by the network entity or selected by the UE.

The reference signal resource used in the underlying QCL assumption (e.g., the assumed QCL relationship between a reference signal resource and a receive beam of the UE) may, in some examples, correspond to a preferred downlink precoding beam point direction (e.g., azimuth angle and elevation angle) for the UE. In some examples, the network entity may configure the UE with a set of rules (e.g., criteria) for selecting a QCL source (e.g., a reference signal resource used in the underlying QCL assumption). Alternatively, the network entity may configure the UE to use a specific reference signal resource in the QCL assumption (e.g., rather than the UE dynamically selecting a QCL source).

Aspects of the present disclosure may be implemented to realize one or more of the following advantages. The described techniques may enable a UE to provide a network entity with QCL information associated with a downlink precoding matrix, which may enable the network entity to more effectively utilize and interpret the downlink precoding matrix. For example, the network entity may use the QCL information provided by the UE to determine which transmit beams or transmission configuration indicator (TCI) states to use for subsequent communications with the UE. Thus, configuring the UE to report QCL information in accordance with examples described herein may improve the likelihood of successful communications between the UE and the network entity.

Aspects of the disclosure are initially described in the context of wireless communications systems, resource diagrams, and process flows. Aspects of the disclosure are further illustrated by and described herein with reference to apparatus diagrams, system diagrams, and flowcharts that relate to techniques for reporting QCL information.

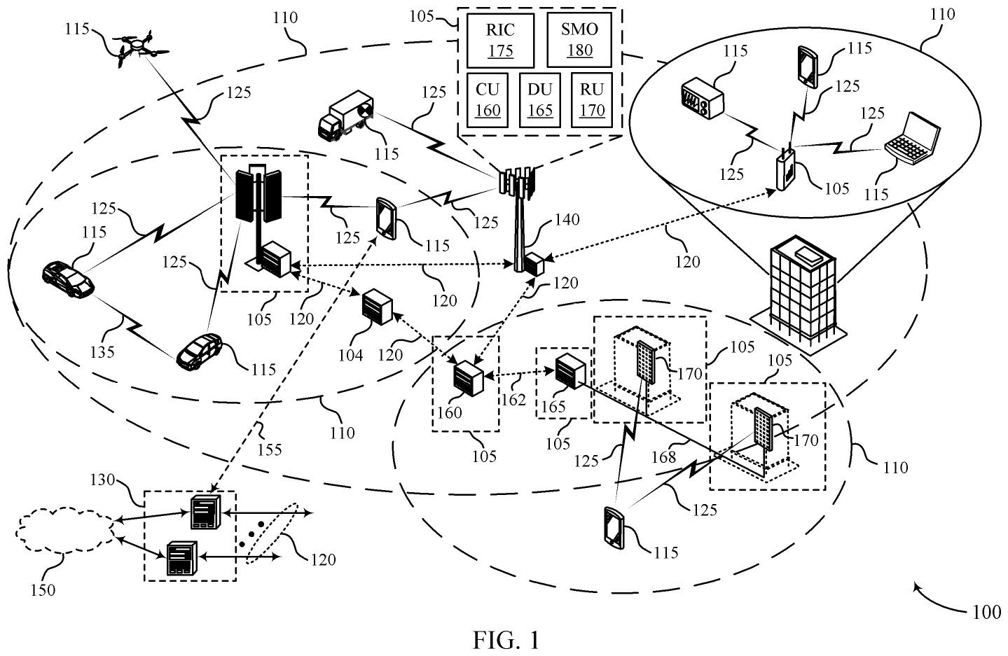

FIG. 1 illustrates an example of a wireless communications system 100 that supports techniques for reporting QCL information in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for reporting QCL information as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described herein with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some wireless communications systems, a UE 115 may perform CSI-RS or SSB beam sweeping operations. The UE 115 may perform the beam sweeping operations during a random access channel (RACH) procedure or an initial access procedure. During the beam sweeping operations, the UE 115 may measure wider beams (e.g., L1 beams) and report a beam refinement indication to a network entity 105. The UE 115 may select a beam pair based on beam measurements and connect to the network entity 105 (e.g., using P1, P2, P3, U1, U2, or U3 processes). In some cases, if the connection is unsuccessful, the UE 115 may perform a beam failure recovery (BFR) procedure to reconnect with the network entity 105. If the UE 115 is unable to maintain a connection with the network entity 105, the UE 115 may initiate a radio link failure (RLF) procedure.

In some cases, the UE 115 may use AI and ML algorithms to perform beam sweeping operations. The framework for AI and ML algorithms used in air-interface applications may have varying performance and complexity considerations. The use of AI and ML algorithms can provide channel state information (CSI) feedback enhancement, overhead reduction, improved accuracy, improved beam prediction management (e.g., in a time domain or a spatial domain), overhead and latency reduction, and improved beam selection accuracy. These benefits may be applicable to communication channels with non-line-of-sight (NLOS) channel conditions. AI and ML beam sweeping approaches may support various collaboration levels between the network entity 105 and the UE 115.

In some AI and ML-based beam prediction procedures, a UE 115 may use wide beams to determine (e.g., predict) narrow beams for a subsequent time period. The UE 115 may measure these wide beams and approximate the narrow beams using ML or AI algorithms that are based on previous measurements of wide beams, previous narrow beam estimations, or both. AI and ML-assisted beam prediction techniques may reduce beam measurement overhead, decrease CSI-RS and SSB resource overhead, and improve beam point accuracy for the UE 115.

Additionally or alternatively, some wireless communication systems may support CSI-RS and SSB resource selection codebooks for beam prediction (e.g., analog beamforming for mmW). For example, a network entity 105 may transmit a set of CSI-RSs or SSBs to the UE 115 using a set of CSI-RS or SSB resources associated with analog or hybrid communication beams. Accordingly, the UE 115 may select one or more CSI-RS or SSB resources to use for beam prediction. The UE 115 may generate PMI feedback based on a linear combination of the selected CSI-RS or SSB resources. In some cases, the PMI feedback may correspond to a wideband (WB) beam. In other cases, the PMI feedback may correspond to a sub-band (SB) beam. In cases of SB-specific beams, the UE 115 may transmit a SB-specific coefficient report to the network entity 105. Additionally, or alternatively, the UE 115 may use frequency domain compression and report the SB-specific coefficients to the network entity 105.

Some wireless communication systems may also support joint CSI-RS resource and CSI-RS port selection codebooks for beam prediction (e.g., hybrid beamforming for mmW with two digital RF chains). For example, a network entity 105 may transmit a set of CSI-RSs to a UE 115. The network entity 105 may use CDM, FDM, or TDM to transmit the CSI-RSs. The UE 115 may select CSI-RS resources and CSI-RS ports based on measured channel conditions. The UE 115 may generate PMI feedback based on a linear combination of the selected joint CSI-RS resources and CSI-RS ports, and may transmit the PMI feedback to the network entity 105. In some cases, the PMI feedback may correspond to WB-specific beams. In other cases, the PMI feedback may correspond to SB-specific beam. For SB-specific beams, the UE 115 may transmit an SB-specific coefficient report to the network entity 105. Additionally, or alternatively, the UE 115 may use frequency domain compression and report the SB-specific coefficients to the network entity.

Aspects of the wireless communications system 100 may be implemented to realize one or more of the following advantages. The techniques described herein with reference to FIG. 1 may enable a UE 115 to provide a network entity 105 with QCL information associated with a downlink precoding matrix, which may enable the network entity 105 to more effectively utilize and interpret the downlink precoding matrix. For example, the network entity 105 may use the QCL information provided by the UE 115 to determine which transmit beams or TCI states to use for subsequent communications with the UE 115. Thus, configuring the UE 115 to report QCL information in accordance with examples described herein may improve the likelihood of successful communications between the UE 115 and the network entity 105.

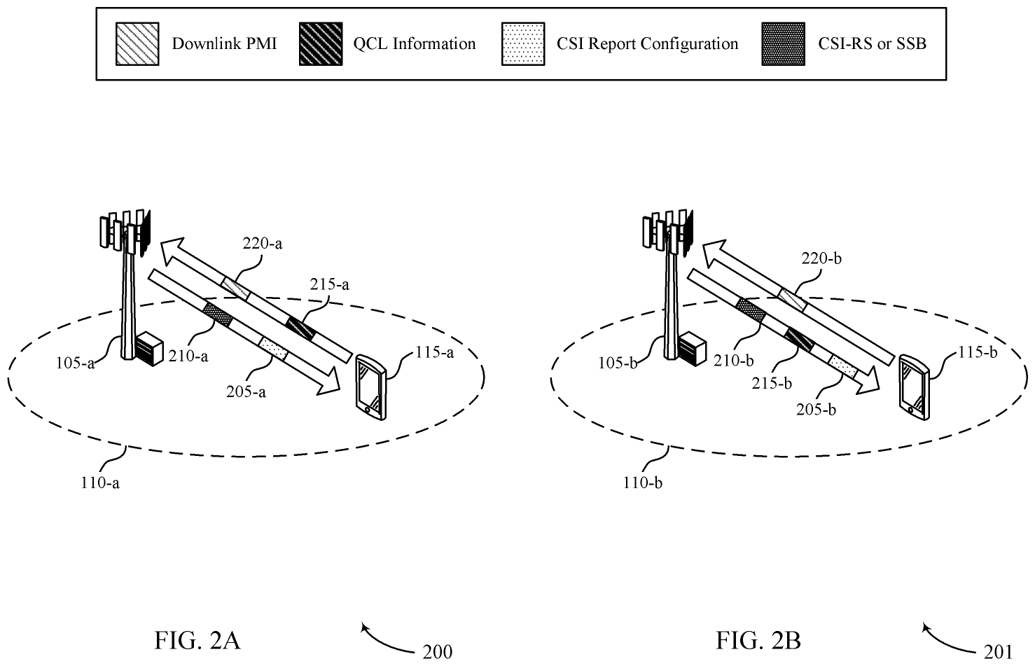

FIGS. 2A and 2B illustrate examples of a wireless communications system 200 and a wireless communications system 201 that support techniques for reporting QCL information in accordance with one or more aspects of the present disclosure. The wireless communications system 200 and the wireless communications system 201 may implement or be implemented by aspects of wireless communications system 100. For example, the wireless communications system 200 and the wireless communications system 201 may include a UE 115-a and a UE 115-b, which may be examples of a UE 115 described herein with reference to FIG. 1. Likewise, the wireless communications system 200 and the wireless communications system 201 may include a network entity 105-a and a network entity 105-b, which may be examples of a network entity 105 described herein with reference to FIG. 1. The UEs 115 and the network entities 105 of the wireless communications system 200 and the wireless communications system 201 may communicate within a coverage area 110-a and a coverage area 110-b, which may be examples of a coverage area 110 described herein with reference to FIG. 1.

In some wireless communications systems, communication devices may determine downlink precoding information based CSI-RS or SSB measurements and assumed QCL information. In some cases, QCL information associated with CSI-RSs and SSBs used to calculate this downlink precoding information may not be provided to the network. Without an indication of the QCL information used to determine the downlink precoding information, the network may be unable to determine which downlink TCI states to use for subsequent physical downlink shared channel (PDSCH) transmissions.

Some communication devices may also be configured to report preferred azimuth angle of departure (AoD) and zenith angle of departure (ZoD) values that are based on measurements of CSI-RSs and SSBs. However, the network may be unable to properly interpret or apply this information without access to QCL information that was used to determine these values. Thus, it may be beneficial for communication devices to report QCL information that is used to calculate downlink precoding. Alternatively, the network can configure communication devices to use specific QCL assumptions by signaling different CSI report settings (e.g., via RRC signaling).

The techniques described herein provide mechanisms for reporting QCL information used in downlink precoding computations. In the example of FIG. 2A, the UE 115-a may receive an indication of a CSI report configuration 205-a from the network entity 105-a. The CSI report configuration 205-a may indicate a set of reference signal resources that the UE 115-a can use as a QCL source for a downlink PMI 220-a. For example, the CSI report configuration 205-a may indicate a set of reference signal resource identifiers that can be used for downlink precoding calculations. In some examples, the UE 115-a may determine which reference signal resources can be used in downlink QCL assumptions based on a CSI report setting signaled by the CSI report configuration 205-a. Additionally or alternatively, the CSI report configuration 205-a may indicate a set of rules or parameters for selecting a QCL source (e.g., a reference signal resource used as a reference for calculating the downlink PMI 220-a).

The UE 115-a may receive CSI-RS or SSB 210-a from the network entity 105-a via a set of CSI-RS or SSB resources. The UE 115-a may select one or more resources from the set of CSI or SSB resources based on measurements associated with the CSI-RS or SSB 210-a. The UE 115-a may select or otherwise determine QCL information 215-a based on the measurements of the CSI or SSB 210-a and the information provided in the CSI report configuration 205-a. Accordingly, the UE 115-a may use the QCL information 215-a (e.g., a QCL assumption associated with a reference signal resource) to determine the downlink PMI 220-a. The UE 115-a may transmit an indication of the downlink PMI 220-a and the QCL information 215-a to the network entity 105-a via a CSI report. In some examples, the UE 115-a may indicate the QCL information 215-a via a CSI report field.

In the example of FIG. 2B, the UE 115-b may receive an indication of a CSI report configuration 205-b from the network entity 105-b. The CSI report configuration 205-b may indicate a set of reference signal resources that the UE 115-b can use as a QCL source for a downlink PMI 220-b. For example, the CSI report configuration 205-b may indicate a set of reference signal resource identifiers that can be used for downlink precoding calculations. In some examples, the UE 115-b may determine which reference signal resources can be used for QCL assumptions based on a CSI report setting signaled by the CSI report configuration 205-b. Alternatively, the CSI report configuration 205-b may configure the UE 115-b to use a specific reference signal resource for QCL assumptions related to the downlink PMI 220-b. That is, the network entity 105-b may instruct the UE 115-b to use a specific QCL source for the downlink PMI 220-b.

The UE 115-b may also receive an indication of QCL information 215-b from the network entity 105-b. The UE 115-b may receive this indication via downlink control information (DCI) or a MAC-CE, among other examples. The QCL information 215-b may indicate a Type-D QCL assumption (e.g., spatial relationship) for the UE 115-b to use in downlink precoding calculations. In some examples, the network entity 105-b may use different CSI triggering states to indicate different Type-D QCL assumptions. The Type-D QCL assumption indicated by the network entity 105-b may correspond to a CSI-RS resource, an SSB resource, an uplink reference signal resource, a downlink reference signal resource, or any other resource indicated by the CSI report configuration 205-b.

Accordingly, the UE 115-b may receive CSI-RS or SSB 210-b from the network entity 105-b via a set of CSI-RS or SSB resources. The UE 115-b may select one or more resources from the set of CSI-RS or SSB resources based on measurements associated with the CSI-RS or SSB 210-b. The UE 115-b may use the QCL information 215-b to determine the downlink PMI 220-b, which may include a linear combination of the selected CSI-RS or SSB resources. The UE 115-b may transmit an indication of the downlink PMI 220-b to the network entity 105-b via a CSI report. In some examples, the UE 115-b may include other information (e.g., a preferred beam point direction, a preferred CSI-RS port configuration) in the CSI report as well.

Aspects of the wireless communications system 200 and the wireless communications system 201 may be implemented to realize one or more of the following advantages. The techniques described herein with reference to FIGS. 2A and 2B may enable the UE 115-a to provide the network entity 105-a with the QCL information 215-a associated with the downlink PMI 220-a, which may enable the network entity 105-a to more effectively utilize and interpret the downlink PMI 220-a. For example, the network entity 105-a may use the QCL information 215-a provided by the UE 115-a to determine which transmit beams or TCI states to use for subsequent communications with the UE 115-a. Thus, configuring the UE 115-a to report the QCL information 215-a in accordance with examples described herein may improve the likelihood of successful communications between the UE 115-a and the network entity 105-a.

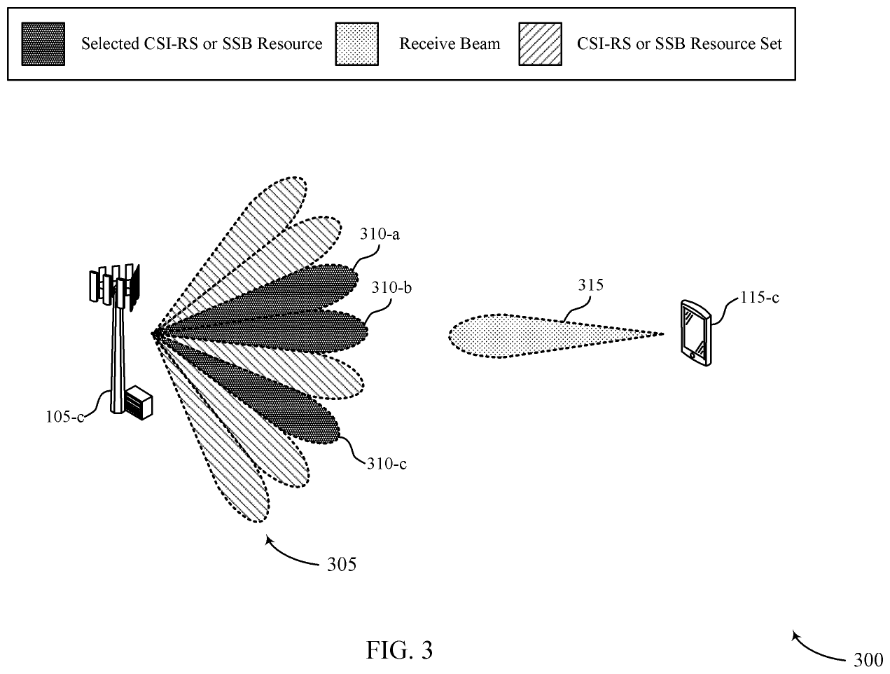

FIG. 3 illustrates an example of a resource diagram 300 that supports techniques for reporting QCL information in accordance with one or more aspects of the present disclosure. The resource diagram 300 may implement or be implemented by aspects of the wireless communications system 100, the wireless communications system 200, or the wireless communications system 201. For example, the resource diagram 300 may include a network entity 105-c and a UE 115-c, which may be examples of corresponding devices with reference to FIGS. 1 and 2. The resource diagram 300 may illustrate a spatial relationship between resources of a CSI-RS or SSB resource set 305 and a receive beam 315 of the UE 115-c.

The resource diagram 300 may support various QCL report enhancements in accordance with examples described herein. In some examples, the UE 115-c may be configured with a CSI report setting associated with the CSI-RS or SSB resource set 305, which may enable the UE 115-c to determine and report an implicit downlink PMI based on CSI-RS or SSB resources within the CSI-RS or SSB resource set 305. In addition, the UE 115-c may report and identify (or the network entity 105-c implicitly determine based on predefined rules) QCL information assumed when determining implicit downlink precoding information.

As described herein, the terms QCL assumption and QCL information may refer to an assumed QCL relationship between a reference signal resource and a receive beam 315 of the UE 115-c. The UE 115-c may use this QCL information to derive precoding information for a downlink channel between the UE 115-c and the network entity 105-c. For example, the UE 115-c may assume a specific QCL relationship (e.g., correlation) between a CSI-RS or SSB resource 310-b and the receive beam 315 of the UE 115-c, and may use this QCL relationship to perform implicit beam prediction, as described herein.

In some examples, the UE 115-c may select at least one of the CSI-RS or SSB resources within the CSI-RS or SSB resource set 305, and may report the selected CSI-RS or SSB resources to the network entity 105-c. For example, the UE 115-c may select a CSI-RS or SSB resource 310-a, a CSI-RS or SSB resource 310-b, and a CSI-RS or SSB resource 310-c from the CSI-RS or SSB resource set 305 based on measurements associated with the CSI-RS or SSB resource set 305. Alternatively, the UE 115-c may identify a downlink or uplink resource that is different from any of the CSI-RS or SSB resources within the CSI-RS or SSB resource set 305. The other downlink or uplink resources that can be identified and reported as a QCL source for the reported downlink PMI may be configured by the network entity 105-c (e.g., via RRC signaling). The network entity 105-c may configure these downlink or uplink resources using a CSI report setting that indicates resources or resource set identifiers. Alternatively, the network entity 105-c may configure these resources using a CSI report setting that is linked with a different CSI resource setting.

In some examples, the UE 115-c may use the selected CSI-RS or SSB resources to calculate a downlink PMI. In such examples, the implicit downlink PMI may be based on reporting one or more selection sets of a number of CSI-RS or SSB resources within the CSI-RS or SSB resource set 305, quantized linear combination coefficients associated with the selected CSI-RS or SSB resources, and at least a layer one (L1) reference signal received power (RSRP) or an L1 signal to interference and noise ratio (SINR) associated with the downlink PMI.

The UE 115-c may, in some examples, report joint CSI-RS and CSI-RS port selection information to the network entity 105-c. For example, the UE 115-c may report one or more selection sets of a number of the CSI-RS resources within a CSI-RS resource set, a selection set of a number of CSI-RS ports, quantized linear combination coefficients associated with the selected CSI-RS resources and the selected CSI-RS ports associated with the one or more selected CSI-RS resources, an L1-RSRP or L1-SINR associated with the determined PMI, or any combination thereof.

Additionally, or alternatively, the UE 115-c may report a preferred beam point direction (e.g., azimuth angle and elevation angle) to the network entity 105-c. The UE 115-c may calculate the implicit downlink precoding information based on reporting the preferred beam point direction for the downlink PMI to the network entity 105-c (in addition to reporting measurements for the CSI-RS or SSB resource set 305). The UE 115-c may also report an L1-RSRP or L1-SINR value associated with the preferred beam point direction.

In some examples, the network entity 105-c may configure the QCL information for the downlink PMI that is implicitly determined by the UE 115-c. As described herein, implicitly determining downlink precoding information may refer to the UE 115-c using measurements and information from a previous time period to predict a suitable downlink precoding matrix for a subsequent time period. The UE 115-c may be configured with a CSI report setting associated with the CSI-RS or SSB resource set 305 such that the UE 115-c can determine and report implicit downlink precoding information using resources in the CSI-RS or SSB resource set 305. Thus, the UE 115-c may assume the QCL information for determining the implicit downlink PMI based on information provided by the network entity 105-c.

The UE 115-c may calculate downlink precoding information based on one of the CSI-RS or SSB resources within the CSI-RS or SSB resource set 305. Alternatively, the UE 115-c may calculate a downlink PMI (also referred to herein as downlink precoding information or a downlink precoding matrix) based on downlink or uplink resources that are different from any of the CSI-RS or SSB resources in the CSI-RS or SSB resource set 305. In some examples, the network entity 105-c may dynamically alter the QCL information for implicit beam predictions at the UE 115-c.

The network entity 105-c may indicate which resource to use as a QCL reference (e.g., QCL source) via a MAC-CE or an instance of DCI. The dynamically signaled QCL information may, in some examples, replace or override QCL information from a previous CSI report setting. When the QCL information is signaled via DCI, the network entity 105-c may use different CSI triggering states to indicate different QCL sources. That is, different CSI trigger states may be associated with different reference signal resource identifiers. The network entity 105-c may signal (e.g., via DCI) different CSI triggering state identifiers to dynamically change QCL information used for implicit beam prediction at the UE 115-c.

Aspects of the resource diagram 300 may be implemented to realize one or more of the following advantages. The techniques described herein with reference to FIG. 3 may enable the UE 115-c to provide the network entity 105-c with QCL information associated with a downlink precoding matrix, which may enable the network entity 105-c to more effectively utilize and interpret the downlink precoding matrix. For example, the network entity 105-c may use the QCL information provided by the UE 115-c to determine which transmit beams or TCI states to use for subsequent communications with the UE 115-c. Thus, configuring the UE 115-c to report QCL information in accordance with examples described herein may improve the likelihood of successful communications between the UE 115-c and the network entity 105-c.

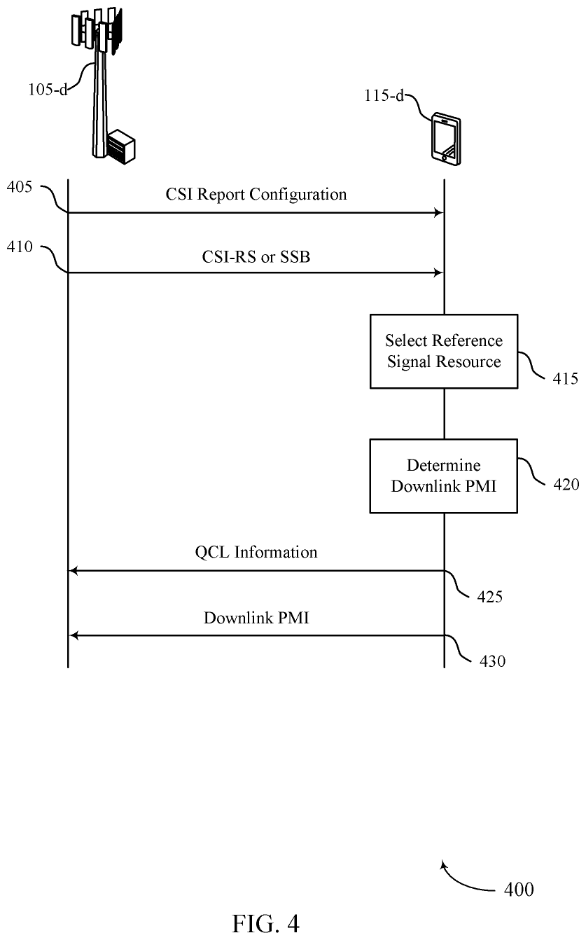

FIG. 4 illustrates an example of a process flow 400 that supports techniques for reporting QCL information in accordance with one or more aspects of the present disclosure. The process flow 400 may implement or be implemented by aspects of the wireless communications system 100, the wireless communications system 200, the wireless communications system 201, or the resource diagram 300, as described herein with reference to FIGS. 1 through 3. For example, the process flow 400 may include a UE 115-d and a network entity 105-d, which may be examples of corresponding devices described herein with reference to FIGS. 1 through 3. In the following description of the process flow 400, operations between the UE 115-d and the network entity 105-d may be performed in a different order or at a different time than as shown. Additionally, or alternatively, some operations may be omitted from the process flow 400 and other operations may be added to the process flow 400.

At 405, the network entity 105-d may output (e.g., transmit) an indication of a CSI report configuration (e.g., the CSI report configuration 205-a described herein with reference to FIG. 2A). The CSI report configuration may indicate, for example, a set of reference signal resources that are can be used as a QCL source for downlink precoding operations at the UE 115-d. In some examples, the CSI report configuration may indicate specific resource identifiers that can be used in QCL assumptions. In other examples, the UE 115-d may determine which reference signal resources can be used as a QCL source based on a CSI report setting indicated by the CSI report configuration.

At 410, the UE 115-d may receive one or more CSI-RSs or SSBs from the network entity 105-d. The UE 115-d may receive the CSI-RSs and SSBs via CSI-RS and SSB resources that correspond to different spatial directions (e.g., communication beams). At 415, the UE 115-d may select one or more CSI-RS or SSB resources from the CSI-RS or SSB resource set based on channel measurements (e.g., SINR, RSRP) associated with the selected CSI-RS or SSB resources. At 420, the UE 115-d may determine a downlink precoding matrix (e.g., downlink PMI, downlink precoding information) using QCL information associated with a reference signal resource.

At 425, the UE 115-d may report the QCL information to the network entity 105-d. Likewise, the UE 115-d may report the downlink PMI to the network entity 105-d at 430. The UE 115-d may include the downlink precoding information and the QCL information in the same CSI report or in different CSI reports. In some examples, the CSI report may also include channel measurements (e.g., RSRP, SINR) related to the CSI-RSs or SSBs. The UE 115-d may signal the QCL information using a CSI report field. In some examples, the network entity 105-d may determine which reference signal resource was used as a QCL source for the downlink PMI based on the channel measurements included in the CSI report.

In some examples, the UE 115-d may determine the downlink PMI based on rules indicated by the CSI report configuration. These rules may configure the UE 115-d to use QCL information associated with any of the selected CSI-RS or SSB resources. Alternatively, the UE 115-d may use QCL information corresponding to the selected CSI-RS or SSB resource with the strongest L1-RSRP or L1-SINR. In some examples, the UE 115-d may report an SSB index RSRP, an SSB index SINR, a CSI-RS resource indicator (CRI) RSRP, or a CRI-SINR associated with the CSI-RS or SSB resource set. The UE 115-d may these measurements in the CSI report that includes the downlink precoding information or in a different CSI report. The network entity 105-d may, in some examples, determine (e.g., assume) that a CSI-RS or SSB resource with the highest L1-RSRP or L1-SINR (as indicated by the CSI report) was used as a QCL source for the downlink precoding information.

In other examples, the UE 115-d may determine the downlink PMI based on other downlink or uplink reference signal resources that are different from CSI-RS or SSB resources in the downlink PMI. The UE 115-d may determine which resource to use based on CSI report settings configured by the network entity 105-d. For example, the UE 115-d may select (e.g., as the QCL source) a downlink or uplink reference signal resource that is QCL-ed with at least one of the selected CSI-RS or SSB resources. Alternatively, the UE 115-d may select a downlink or uplink reference signal resource that is QCL-ed with a CSI-RS or SSB resource having the highest L1-RSRP or L1-SINR value among all CSI-RS or SSB resources from the linear combination of CSI-RS or SSB resources in the downlink PMI.

The UE 115-d may also report joint CSI-RS and CSI-RS port selection information to the network entity 105-d (e.g., in addition to the downlink precoding information). In some examples, the QCL source for the downlink PMI may correspond to a CSI-RS resource in the downlink PMI. Alternatively, the QCL source for the downlink PMI may correspond to a CSI-RS resource with the highest L1-RSRP or L1-SINR value among all CSI-RS resources selected by the UE 115-d. The L1-RSRP or L1-SINR for multi-port CSI-RS resources (e.g., CSI-RS resources that span multiple CSI-RS ports) may refer to an average L1-RSRP across all CSI-RS ports associated with the multi-port CSI-RS resource or a total L1-RSRP across all CSI-RS ports associated with the multi-port CSI-RS resource.

If the UE 115-d selects a QCL source from a set of uplink or downlink reference signal resources outside the CSI-RS or SSB resource set, the QCL source may, in some examples, be QCL-ed with at least one CSI-RS resource from the CSI-RS resources selected for inclusion in the downlink PMI. Alternatively, the downlink or uplink reference signal resource chosen as a QCL source may be QCL-ed with a CSI-RS resource associated with the highest L1-RSRP or L1-SINR among all selected CSI-RS resources. As described herein, L1-RSRP or L1-SINR for multi-port CSI-RS resources may refer to the average L1-RSRP across all CSI-RS ports associated with the multi-port CSI-RS resource or the total L1-RSRP across all CSI-RS ports associated with the multi-port CSI-RS resource.

The UE 115-d may also determine the downlink PMI based on a preferred beam point direction (e.g., azimuth angle and elevation angle). The preferred beam point direction may be derived from information associated with different CSI-RS or SSB resources within the CSI-RS or SSB resources set. Alternatively, this preferred beam point direction may be configured by the network entity 105-d (e.g., using different CSI report settings). For example, the network entity 105-d may configure a preferred beam point direction for CSI-RS or SSB resources using a CSI report setting or a CSI resource set. The CSI-RS or SSB resource and QCL information may be implicitly identified by the network entity 105-d or configured for the UE 115-d based on a beam point direction signaled in the CSI report (from the UE 115-d) or the CSI report configuration (from the network entity 105-d).

In some examples, a beam point direction of the CSI-RS or SSB resource selected as the QCL source for the downlink PMI may have the closest proximity to the preferred beam point direction of the UE 115-d. If multiple CSI-RS or SSB resources have beam point directions that are relatively close to the preferred beam point direction, the resource with the highest or lowest reference signal identifier may be selected as the QCL source. Additionally or alternatively, the UE 115-d may prioritize resources with respect to AoD or ZoD.

In some examples, the CSI report configuration may indicate beam point directions (e.g., AoD and ZoD) for downlink or uplink reference signals that can be used in QCL assumptions for the downlink PMI. For example, beam point directions of other CSI-RS resources may be indicated or configured by a CSI report setting or a CSI resource set associated with the other CSI-RS resources. The reference signal resource selected as the QCL source (e.g., the reference signal resource used in QCL assumptions related to the downlink PMI) may be implicitly identified by the network entity 105-d or configured for the UE 115-d based on the indicated beam point directions.

For example, the UE 115-d may be configured to select (e.g., as the QCL source) a downlink or uplink reference signal resource with a beam point direction that is closest to the preferred beam point direction. The proximity between a reference signal resource and the preferred beam point direction may be determined using AoD, ZoD, or both. In some examples, different resources may be prioritized by AoD proximity or ZoD proximity. If multiple downlink or uplink reference signal resources satisfy a proximity threshold for the preferred beam point direction, the UE 115-d may prioritize the reference signals by direction (e.g., downlink or uplink), resource type (e.g., CSI-RS or SSB), and resource identifier (e.g., highest or lowest resource identifier).

Aspects of the process flow 400 may be implemented to realize one or more of the following advantages. The techniques described herein with reference to FIG. 4 may enable the UE 115-d to provide the network entity 105-d with QCL information associated with a downlink precoding matrix, which may enable the network entity 105-d to more effectively utilize and interpret the downlink precoding matrix. For example, the network entity 105-d may use the QCL information provided by the UE 115-d to determine which transmit beams or TCI states to use for subsequent communications with the UE 115-d. Thus, configuring the UE 115-d to report QCL information in accordance with examples described herein may improve the likelihood of successful communications between the UE 115-d and the network entity 105-d.

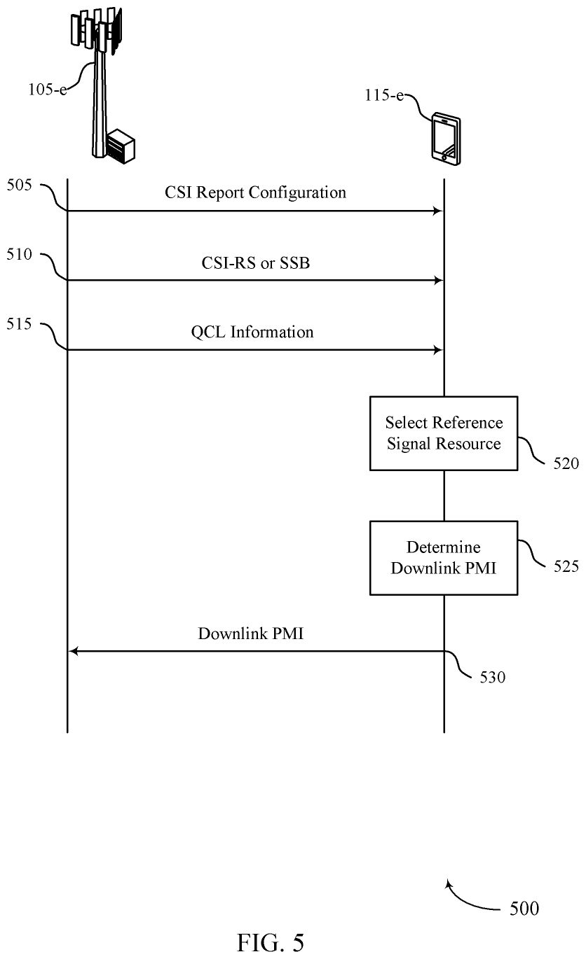

FIG. 5 illustrates an example of a process flow 500 that supports techniques for reporting QCL information in accordance with one or more aspects of the present disclosure. The process flow 500 may implement or be implemented by aspects of the wireless communications system 100, the wireless communications system 200, the wireless communications system 201, the resource diagram 300, or the process flow 400, as described herein with reference to FIGS. 1 through 4. For example, the process flow 500 may include a UE 115-e and a network entity 105-e, which may be examples of corresponding devices described herein with reference to FIGS. 1 through 4. In the following description of the process flow 500, operations between the UE 115-e and the network entity 105-e may be performed in a different order or at a different time than as shown. Additionally, or alternatively, some operations may be omitted from the process flow 500, and other operations may be added to the process flow 500.

At 505, the network entity 105-e may output (e.g., transmit) an indication of a CSI report configuration (e.g., the CSI report configuration 205-b described herein with reference to FIG. 2B). The CSI report configuration may indicate a set of reference signal resources that the UE 115-e can use as a QCL source (e.g., QCL reference) for computing a downlink PMI. For example, the CSI report configuration may indicate a set of reference signal resource identifiers that can be used for downlink precoding calculations. In some examples, the UE 115-e may determine which reference signal resources can be used for QCL assumptions based on a CSI report setting signaled in the CSI report configuration. Alternatively, the network entity 105-e may configure the UE 115-e to use a specific reference signal resource for QCL assumptions related to the downlink PMI. That is, the network entity 105-e may instruct the UE 115-e to use a specific QCL source for the downlink PMI (e.g., using different CSI report settings or CSI trigger fields identifiers). In some examples, the CSI report configuration may specify beam point directions (e.g., angular information) for each reference signal resource that can be used as a QCL source.

At 510, the UE 115-e may receive one or more CSI-RSs or SSBs from the network entity 105-e. The UE 115-e may receive the CSI-RSs and SSBs via CSI-RS and SSB resources that correspond to different spatial directions (e.g., communication beams, transmit beams). At 515, the UE 115-e may receive (e.g., obtain) QCL information from the network entity 105-e. For example, the UE 115-e may receive DCI that includes a CSI trigger field identifier associated with a QCL source (e.g., reference signal resource). The UE 115-e may use the QCL information provided by the network entity 105-e to implicitly determine downlink precoding information for a subsequent time period. At 520, the UE 115-e may select one or more CSI-RS or SSB resources from the CSI-RS or SSB resource set based on channel measurements (e.g., SINR, RSRP) associated with the selected CSI-RS or SSB resources. At 525, the UE 115-e may determine a downlink precoding matrix (e.g., downlink PMI, downlink precoding information) using QCL information associated with a reference signal resource (e.g., a QCL source).

At 530, the UE 115-e may report the downlink PMI to the network entity 105-e via a CSI report. In some examples, the CSI report may also include channel measurements (e.g., RSRP, SINR) related to the CSI-RSs or SSBs. Additionally or alternatively, the CSI report may indicate a preferred beam point direction of the UE 115-e. In some examples, the UE 115-e determines the implicit downlink precoding information based on reporting one or more selection sets of a number of CSI-RS or SSB resources within a CSI-RS or SSB resource set, quantized linear combination coefficients associated with selected CSI-RS or SSB resources, an L1-RSRP or L1-SINR associated with a precoder determined based on linear combinations of CSI-RS or SSB resources, or any combination thereof.

The UE 115-e may also report a joint CSI-RS resource and CSI-RS port selection PMI. The UE 115-e may determine the implicit downlink PMI based on reporting one or more selection sets of a number of CSI-RS resources within a CSI-RS resource set and, for the selected CSI-RS resources, one or more selection sets of a number of CSI-RS ports. In addition to the selected CSI-RS resources and ports, the UE 115-e may also report (e.g., in a CSI report) quantized linear combination coefficients associated with the selected CSI-RS resources and the selected CSI-RS ports associated with the one or more selected CSI-RS resources. In addition, the UE 115-e may report L1-RSRP or L1-SINR measurements associated with a precoder determined based on linear combinations of CSI-RS resources.

Additionally, or alternatively, the UE 115-e may receive an indication of a preferred beam point direction from the network entity 105-e. The UE 115-e may determine the implicit downlink precoding information by reporting the preferred beam point direction for downlink PMI and measurements of CSI-RS or SSB resources. The UE 115-e may also report an L1-RSRP or L1-SINR measurement associated with a beam point direction used to determine the downlink PMI.

Aspects of the process flow 500 may be implemented to realize one or more of the following advantages. The techniques described herein with reference to FIG. 5 may enable the network entity 105-e to provide the UE 115-e with QCL information to use for downlink precoding, which may enable the UE 115-e to calculate downlink precoding information with greater accuracy. For example, the UE 115-e may use the QCL information provided by the network entity 105-e to determine a preferred downlink PMI for subsequent communications with the network entity 105-e. Thus, configuring the UE 115-e with QCL information in accordance with examples described herein may improve the likelihood of successful downlink communications between the UE 115-e and the network entity 105-e.

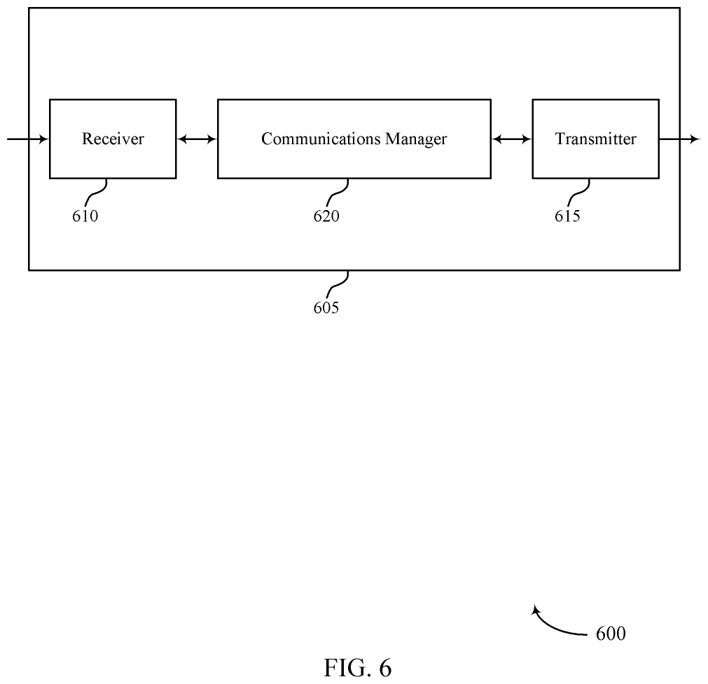

FIG. 6 shows a block diagram 600 of a device 605 that supports techniques for reporting QCL information in accordance with one or more aspects of the present disclosure. The device 605 may be an example of aspects of a UE 115, as described herein. The device 605 may include a receiver 610, a transmitter 615, and a communications manager 620. The device 605 may also include a processor (not shown). Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for reporting QCL information). Information may be passed on to other components of the device 605. The receiver 610 may utilize a single antenna or multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for reporting QCL information). In some examples, the transmitter 615 may be co-located with a receiver 610 in a transceiver module. The transmitter 615 may utilize a single antenna or multiple antennas.

The communications manager 620, the receiver 610, the transmitter 615, or various combinations thereof or various components thereof may be examples of means for performing various aspects of techniques for reporting QCL information as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at the device 605 in accordance with examples disclosed herein. For example, the communications manager 620 may be configured as or otherwise support a means for selecting reference signal resources from a reference signal resource set based on channel measurements associated with the selected reference signal resources. The communications manager 620 may be configured as or otherwise support a means for determining a downlink precoding matrix based on QCL information associated with a reference signal resource, where the downlink precoding matrix includes a combination of the selected reference signal resources. The communications manager 620 may be configured as or otherwise support a means for transmitting a report that indicates the downlink precoding matrix and the reference signal resource associated with the QCL information.

Additionally, or alternatively, the communications manager 620 may support wireless communication at the device 605 in accordance with examples disclosed herein. For example, the communications manager 620 may be configured as or otherwise support a means for receiving control signaling indicating QCL information associated with a reference signal resource. The communications manager 620 may be configured as or otherwise support a means for selecting reference signal resources from a reference signal resource set based on channel measurements associated with the selected reference signal resources. The communications manager 620 may be configured as or otherwise support a means for determining a downlink precoding matrix based on the QCL information, where the downlink precoding matrix includes a combination of the selected reference signal resources. The communications manager 620 may be configured as or otherwise support a means for transmitting a report that indicates the downlink precoding matrix.

By including or configuring the communications manager 620 in accordance with examples as described herein, the device 605 (e.g., a processor controlling or otherwise coupled with the receiver 610, the transmitter 615, the communications manager 620, or any combination thereof) may support techniques for more efficient utilization of communication resources by reducing the resource overhead associated with downlink precoding operations at the device 605. For example, the techniques described herein may enable the device 605 to implicitly determine which communication beams and reference signal resources will have favorable channel conditions (e.g., high SINR and RSRP) based on previous channel measurements, which may reduce the signaling overhead of channel estimation procedures.

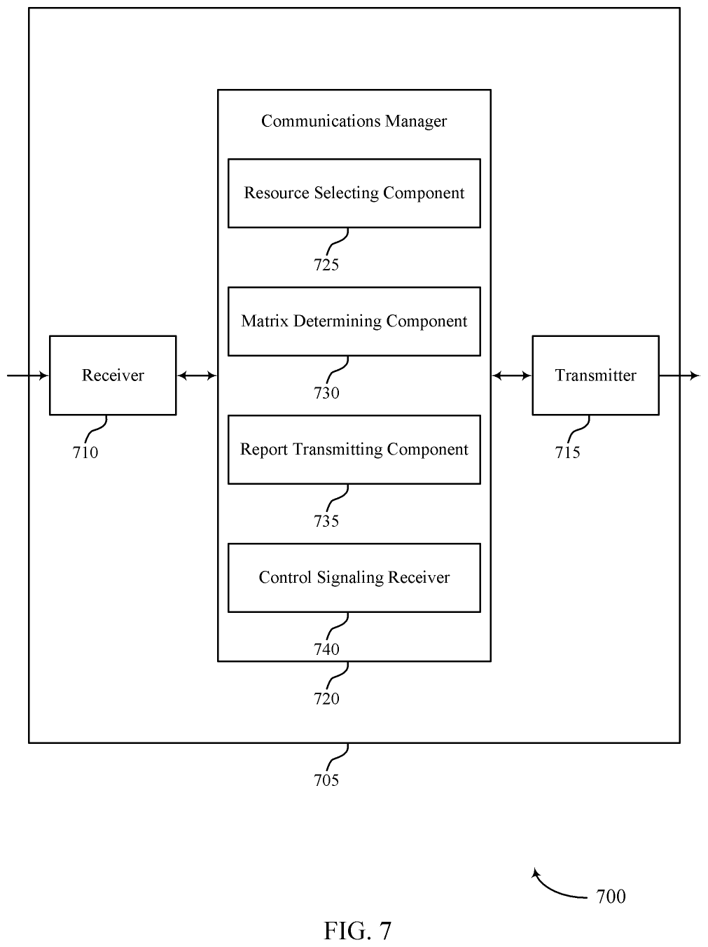

FIG. 7 shows a block diagram 700 of a device 705 that supports techniques for reporting QCL information in accordance with one or more aspects of the present disclosure. The device 705 may be an example of aspects of a device 605 or a UE 115, as described herein. The device 705 may include a receiver 710, a transmitter 715, and a communications manager 720. The device 705 may also include a processor (not shown). Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for reporting QCL information). Information may be passed on to other components of the device 705. The receiver 710 may utilize a single antenna or multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for reporting QCL information). In some examples, the transmitter 715 may be co-located with a receiver 710 in a transceiver module. The transmitter 715 may utilize a single antenna or multiple antennas.

The device 705, or various components thereof, may be an example of means for performing various aspects of techniques for reporting QCL information as described herein. For example, the communications manager 720 may include a resource selecting component 725, a matrix determining component 730, a report transmitting component 735, a control signaling receiver 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at the device 705 in accordance with examples disclosed herein. The resource selecting component 725 may be configured as or otherwise support a means for selecting reference signal resources from a reference signal resource set based on channel measurements associated with the selected reference signal resources. The matrix determining component 730 may be configured as or otherwise support a means for determining a downlink precoding matrix based on QCL information associated with a reference signal resource, where the downlink precoding matrix includes a combination of the selected reference signal resources. The report transmitting component 735 may be configured as or otherwise support a means for transmitting a report that indicates the downlink precoding matrix and the reference signal resource associated with the QCL information.

Additionally, or alternatively, the communications manager 720 may support wireless communication at the device 705 in accordance with examples disclosed herein. The control signaling receiver 740 may be configured as or otherwise support a means for receiving control signaling indicating QCL information associated with a reference signal resource. The resource selecting component 725 may be configured as or otherwise support a means for selecting reference signal resources from a reference signal resource set based on channel measurements associated with the selected reference signal resources. The matrix determining component 730 may be configured as or otherwise support a means for determining a downlink precoding matrix based on the QCL information, where the downlink precoding matrix includes a combination of the selected reference signal resources. The report transmitting component 735 may be configured as or otherwise support a means for transmitting a report that indicates the downlink precoding matrix.

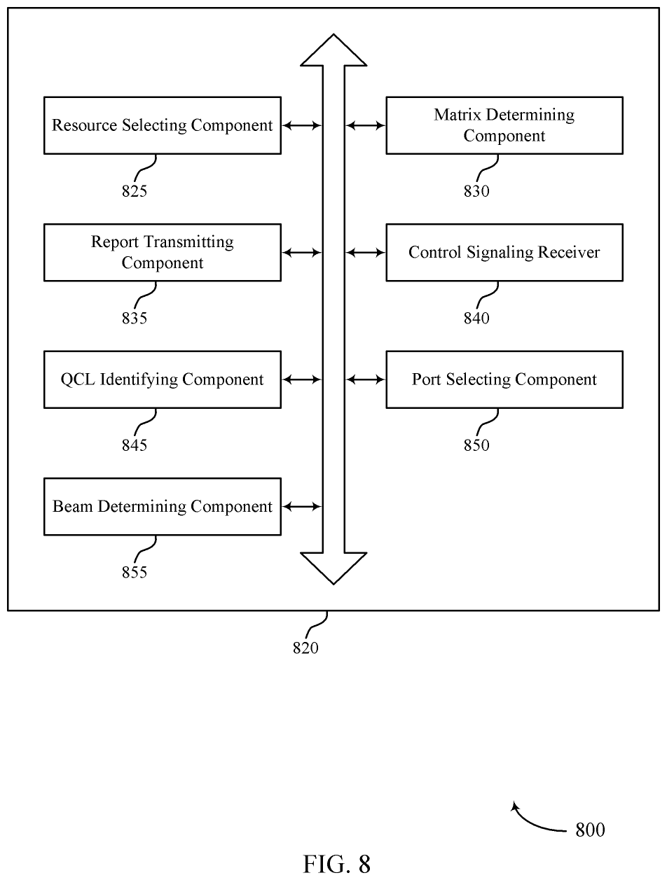

FIG. 8 shows a block diagram 800 of a communications manager 820 that supports techniques for reporting QCL information in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for reporting QCL information as described herein. For example, the communications manager 820 may include a resource selecting component 825, a matrix determining component 830, a report transmitting component 835, a control signaling receiver 840, a QCL identifying component 845, a port selecting component 850, a beam determining component 855, or any combination thereof. Each of these components may communicate, directly or indirectly, with one another (e.g., via one or more buses).

The communications manager 820 may support wireless communication at a UE in accordance with examples disclosed herein. The resource selecting component 825 may be configured as or otherwise support a means for selecting reference signal resources from a reference signal resource set based on channel measurements associated with the selected reference signal resources. The matrix determining component 830 may be configured as or otherwise support a means for determining a downlink precoding matrix based on QCL information associated with a reference signal resource, where the downlink precoding matrix includes a combination of the selected reference signal resources. The report transmitting component 835 may be configured as or otherwise support a means for transmitting a report that indicates the downlink precoding matrix and the reference signal resource associated with the QCL information.

In some examples, the reference signal resource associated with the QCL information may be included in the reference signal resource set. In other examples, the reference signal resource associated with the QCL information may be different from reference signal resources in the reference signal resource set. In some examples, the control signaling receiver 840 may be configured as or otherwise support a means for receiving control signaling indicating one or more reference signal resources that can be used to determine the downlink precoding matrix, where the one or more reference signal resources include the reference signal resource associated with the QCL information.

In some examples, to support transmitting the report, the report transmitting component 835 may be configured as or otherwise support a means for transmitting a CSI report that indicates the selected reference signal resources, a set of linear combination coefficients associated with the selected reference signal resources, an RSRP associated with the downlink precoding matrix, a SINR associated with the downlink precoding matrix, or any combination thereof.

In some examples, the selected reference signal resources include the reference signal resource associated with the QCL information. In some examples, the reference signal resource associated with the QCL information includes a reference signal resource with a highest RSRP or a highest SINR in the selected reference signal resources.

In some examples, the QCL identifying component 845 may be configured as or otherwise support a means for identifying a QCL relationship between one of the selected reference signal resources and the reference signal resource associated with the QCL information.

In some examples, the QCL identifying component 845 may be configured as or otherwise support a means for identifying a QCL relationship between the reference signal resource associated with the QCL information and a reference signal resource having a highest RSRP or a highest SINR in the selected reference signal resources.

In some examples, to support selecting the reference signal resources, the resource selecting component 825 may be configured as or otherwise support a means for selecting CSI-RS resources from a CSI-RS resource set. In some examples, to support selecting the reference signal resources, the port selecting component 850 may be configured as or otherwise support a means for selecting CSI-RS ports for the selected CSI-RS resources.

In some examples, to support transmitting the report, the report transmitting component 835 may be configured as or otherwise support a means for transmitting a CSI report that indicates the selected CSI-RS resources, the selected CSI-RS ports, a set of quantized linear combination coefficients associated with the selected CSI-RS resources and the selected CSI-RS ports, or any combination thereof.

In some examples, the reference signal resource associated with the QCL information includes a CSI-RS resource from the selected CSI-RS resources or a CSI-RS resource that is QCL-ed with at least one of the selected CSI-RS resources. In some examples, the reference signal resource associated with the QCL information includes a CSI-RS resource with a highest RSRP or a highest SINR in the selected CSI-RS resources.

In some examples, the reference signal resource associated with the QCL information includes a multi-port CSI-RS resource with a highest RSRP or a highest SINR in the selected CSI-RS resources. In some examples, the highest RSRP corresponds to an average RSRP across CSI-RS ports associated with the multi-port CSI-RS resource or a total RSRP across CSI-RS ports associated with the multi-port CSI-RS resource.

In some examples, the QCL identifying component 845 may be configured as or otherwise support a means for identifying a QCL relationship between the reference signal resource associated with the QCL information and a CSI-RS resource having a highest RSRP or a highest SINR in the selected CSI-RS resources.

In some examples, the beam determining component 855 may be configured as or otherwise support a means for determining a beam point direction for downlink precoding based on channel measurements associated with the reference signal resource set, where the determined beam point direction is defined by an azimuth angle and an elevation angle.

In some examples, to support transmitting the report, the report transmitting component 835 may be configured as or otherwise support a means for transmitting a CSI report that indicates the determined beam point direction, an RSRP associated with the determined beam point direction, a SINR associated with the determined beam point direction, or any combination thereof.

In some examples, the control signaling receiver 840 may be configured as or otherwise support a means for receiving an indication of a mapping between beam point directions and reference signal resources in the reference signal resource set. In some examples, the resource selecting component 825 may be configured as or otherwise support a means for selecting a reference signal resource from the reference signal resource set based on a beam point direction of the selected reference signal resource having a closest proximity to the determined beam point direction, where the reference signal resource associated with the QCL information includes the selected reference signal resource.

In some examples, the control signaling receiver 840 may be configured as or otherwise support a means for receiving an indication of a mapping between beam point directions and reference signal resources in the reference signal resource set. In some examples, the resource selecting component 825 may be configured as or otherwise support a means for identifying two or more reference signal resources in the reference signal resource set that satisfy a proximity threshold with respect to the determined beam point direction. In some examples, the resource selecting component 825 may be configured as or otherwise support a means for selecting a reference signal resource from the identified two or more reference signal resources based on a reference signal resource identifier associated with the selected reference signal resource, an azimuth angle proximity of the selected reference signal resource, an elevation angle proximity of the selected reference signal resource, or any combination thereof, where the reference signal resource associated with the QCL information includes the selected reference signal resource.

In some examples, the control signaling receiver 840 may be configured as or otherwise support a means for receiving control signaling indicating a mapping between beam point directions and a set of downlink reference signal resources that are different from reference signal resources in the reference signal resource set. In some examples, the resource selecting component 825 may be configured as or otherwise support a means for selecting a downlink reference signal resource from the set of downlink reference signal resources based on a beam point direction of the selected downlink reference signal resource having a closest proximity to the determined beam point direction, where the reference signal resource associated with the QCL information includes the selected downlink reference signal resource.

In some examples, the control signaling receiver 840 may be configured as or otherwise support a means for receiving control signaling indicating a mapping between beam point directions and a set of downlink reference signal resources that are different from reference signal resources in the reference signal resource set. In some examples, the resource selecting component 825 may be configured as or otherwise support a means for identifying two or more downlink reference signal resources in the set of downlink reference signal resources that satisfy a proximity threshold with respect to the determined beam point direction. In some examples, the resource selecting component 825 may be configured as or otherwise support a means for prioritizing the two or more downlink reference signal resources with respect to resource type, resource identifier, azimuth angle proximity, elevation angle proximity, or any combination thereof. In some examples, the resource selecting component 825 may be configured as or otherwise support a means for selecting a downlink reference signal resource from the prioritized two or more downlink reference signal resources, where the reference signal resource associated with the QCL information includes the selected downlink reference signal resource.

Additionally, or alternatively, the communications manager 820 may support wireless communication at a UE in accordance with examples disclosed herein. The control signaling receiver 840 may be configured as or otherwise support a means for receiving control signaling indicating QCL information associated with a reference signal resource. In some examples, the resource selecting component 825 may be configured as or otherwise support a means for selecting reference signal resources from a reference signal resource set based on channel measurements associated with the selected reference signal resources. In some examples, the matrix determining component 830 may be configured as or otherwise support a means for determining a downlink precoding matrix based on the QCL information, where the downlink precoding matrix includes a combination of the selected reference signal resources. In some examples, the report transmitting component 835 may be configured as or otherwise support a means for transmitting a report that indicates the downlink precoding matrix.

In some examples, to support receiving the control signaling, the control signaling receiver 840 may be configured as or otherwise support a means for receiving downlink control information that indicates a CSI triggering state identifier associated with the reference signal resource to use for the QCL information.

In some examples, to support transmitting the report, the report transmitting component 835 may be configured as or otherwise support a means for transmitting a CSI report that indicates the selected reference signal resources, quantized linear combination coefficients associated with the selected reference signal resources, an RSRP associated with the downlink precoding matrix, a SINR associated with the downlink precoding matrix, or any combination thereof.

In some examples, to support selecting the reference signal resources, the resource selecting component 825 may be configured as or otherwise support a means for selecting CSI-RS resources from a CSI-RS resource set. In some examples, to support selecting the reference signal resources, the resource selecting component 825 may be configured as or otherwise support a means for selecting CSI-RS ports for the selected CSI-RS resources.

In some examples, to support transmitting the report, the report transmitting component 835 may be configured as or otherwise support a means for transmitting a CSI report that indicates the selected CSI-RS resources, the selected CSI-RS ports, a set of quantized linear combination coefficients associated with the selected CSI-RS resources and the selected CSI-RS ports, an RSRP associated with the downlink precoding matrix, a SINR associated with the downlink precoding matrix, or any combination thereof.

In some examples, the beam determining component 855 may be configured as or otherwise support a means for determining a beam point direction for downlink precoding based on channel measurements associated with the reference signal resource set, where the determined beam point direction is defined by an azimuth angle and an elevation angle.

In some examples, to support transmitting the report, the report transmitting component 835 may be configured as or otherwise support a means for transmitting a CSI report that indicates the determined beam point direction, an RSRP associated with the determined beam point direction, a SINR associated with the determined beam point direction, or any combination thereof.

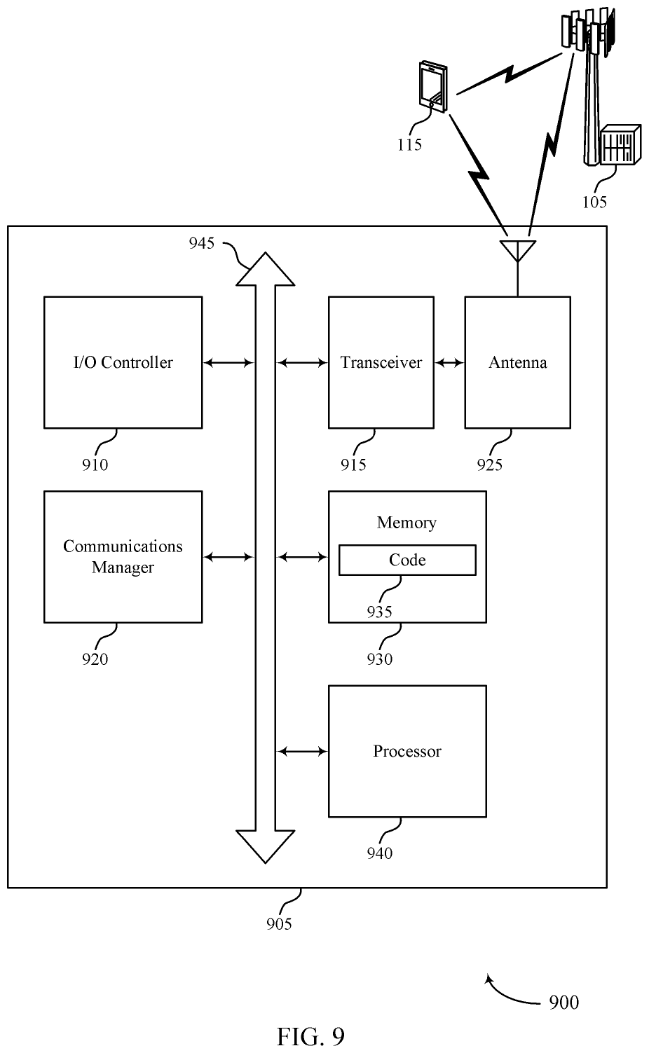

FIG. 9 shows a diagram of a system 900 including a device 905 that supports techniques for reporting QCL information in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for reporting QCL information). For example, the device 905 or a component of the device 905 may include a processor 940 and memory 930 coupled with or to the processor 940, the processor 940 and memory 930 configured to perform various functions described herein.

The communications manager 920 may support wireless communication at the device 905 in accordance with examples disclosed herein. For example, the communications manager 920 may be configured as or otherwise support a means for selecting reference signal resources from a reference signal resource set based on channel measurements associated with the selected reference signal resources. The communications manager 920 may be configured as or otherwise support a means for determining a downlink precoding matrix based on QCL information associated with a reference signal resource, where the downlink precoding matrix includes a combination of the selected reference signal resources. The communications manager 920 may be configured as or otherwise support a means for transmitting a report that indicates the downlink precoding matrix and the reference signal resource associated with the QCL information.

Additionally, or alternatively, the communications manager 920 may support wireless communication at the device 905 in accordance with examples disclosed herein. For example, the communications manager 920 may be configured as or otherwise support a means for receiving control signaling indicating QCL information associated with a reference signal resource. The communications manager 920 may be configured as or otherwise support a means for selecting reference signal resources from a reference signal resource set based on channel measurements associated with the selected reference signal resources. The communications manager 920 may be configured as or otherwise support a means for determining a downlink precoding matrix based on the QCL information, where the downlink precoding matrix includes a combination of the selected reference signal resources. The communications manager 920 may be configured as or otherwise support a means for transmitting a report that indicates the downlink precoding matrix.

By including or configuring the communications manager 920 in accordance with examples as described herein, the device 905 may support techniques for improved communication reliability and lower resource overhead. For example, the described techniques may enable the device 905 to provide a network entity with QCL information associated with a downlink precoding matrix, which may enable the network entity to more effectively utilize and interpret the downlink precoding matrix. More specifically, the network entity may use the QCL information provided by the device 905 to determine which transmit beams or TCI states to use for subsequent communications with the device 905. Thus, configuring the device 905 to report QCL information in accordance with examples described herein may improve the likelihood of successful communications between the device 905 and the network entity.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described herein with reference to the communications manager 920 may be supported by or performed by the processor 940, the memory 930, the code 935, or any combination thereof. For example, the code 935 may include instructions executable by the processor 940 to cause the device 905 to perform various aspects of techniques for reporting QCL information as described herein, or the processor 940 and the memory 930 may be otherwise configured to perform or support such operations.

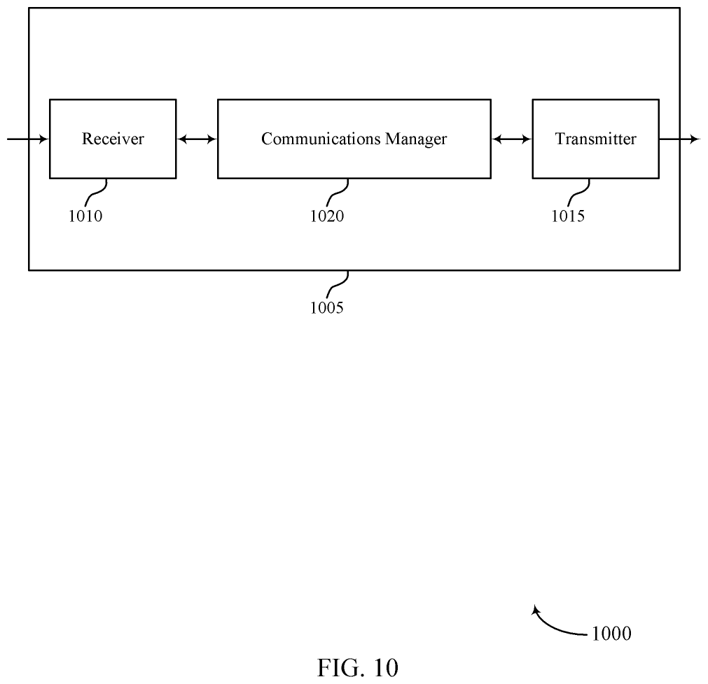

FIG. 10 shows a block diagram 1000 of a device 1005 that supports techniques for reporting QCL information in accordance with one or more aspects of the present disclosure. The device 1005 may be an example of aspects of a network entity 105, as described herein. The device 1005 may include a receiver 1010, a transmitter 1015, and a communications manager 1020. The device 1005 may also include a processor (not shown). Each of these components may be in communication with one another (e.g., via one or more buses).

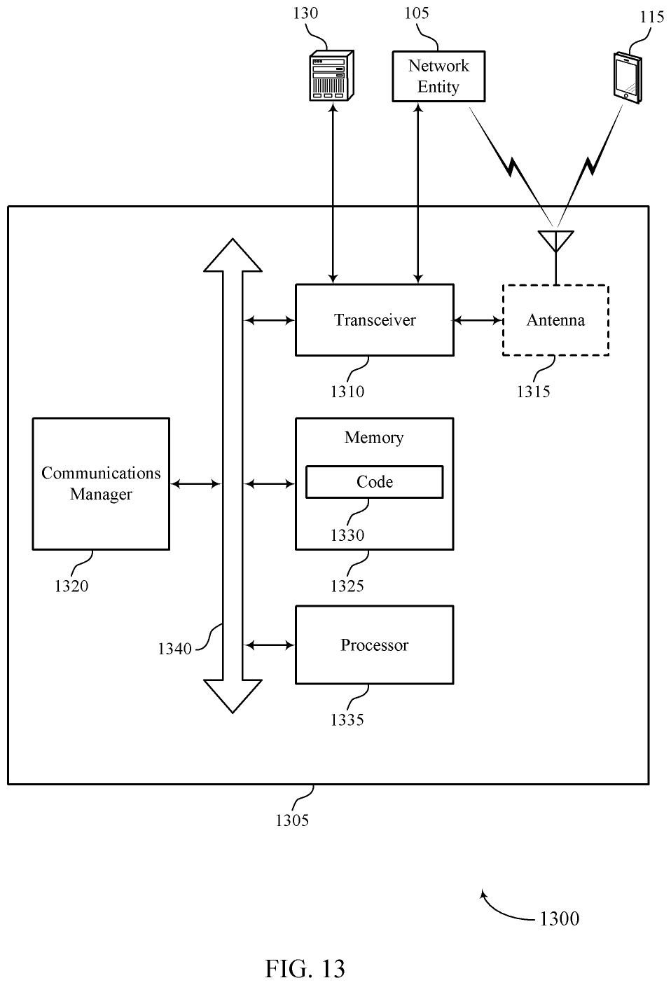

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas (e.g., an antenna 1315 described herein with reference to FIG. 13). Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas (e.g., an antenna 1315 described herein with reference to FIG. 13). Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of techniques for reporting QCL information as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at the device 1005 in accordance with examples disclosed herein. For example, the communications manager 1020 may be configured as or otherwise support a means for outputting one or more reference signals via a reference signal resource set. The communications manager 1020 may be configured as or otherwise support a means for obtaining a report that indicates a downlink precoding matrix and a reference signal resource associated with QCL information used to determine the downlink precoding matrix, where the downlink precoding matrix includes a combination of reference signal resources from the reference signal resource set. The communications manager 1020 may be configured as or otherwise support a means for outputting one or more downlink messages using the downlink precoding matrix indicated by the report.

Additionally, or alternatively, the communications manager 1020 may support wireless communication at the device 1005 in accordance with examples disclosed herein. For example, the communications manager 1020 may be configured as or otherwise support a means for outputting control signaling indicating QCL information associated with a reference signal resource. The communications manager 1020 may be configured as or otherwise support a means for outputting one or more reference signals via a reference signal resource set. The communications manager 1020 may be configured as or otherwise support a means for obtaining an indication of a downlink precoding matrix that is based on the QCL information, where the downlink precoding matrix includes a combination of reference signal resources from the reference signal resource set. The communications manager 1020 may be configured as or otherwise support a means for outputting one or more downlink messages using the downlink precoding matrix.

By including or configuring the communications manager 1020 in accordance with examples as described herein, the device 1005 (e.g., a processor controlling or otherwise coupled with the receiver 1010, the transmitter 1015, the communications manager 1020, or any combination thereof) may support techniques for more efficient utilization of communication resources by reducing the signaling overhead associated with downlink precoding operations at the device 1005. For example, the techniques described herein may enable the device 1005 to obtain implicitly predicted downlink precoding information based on previous reference signal measurements, which may reduce the number of reference signal transmissions performed by the device 1005.

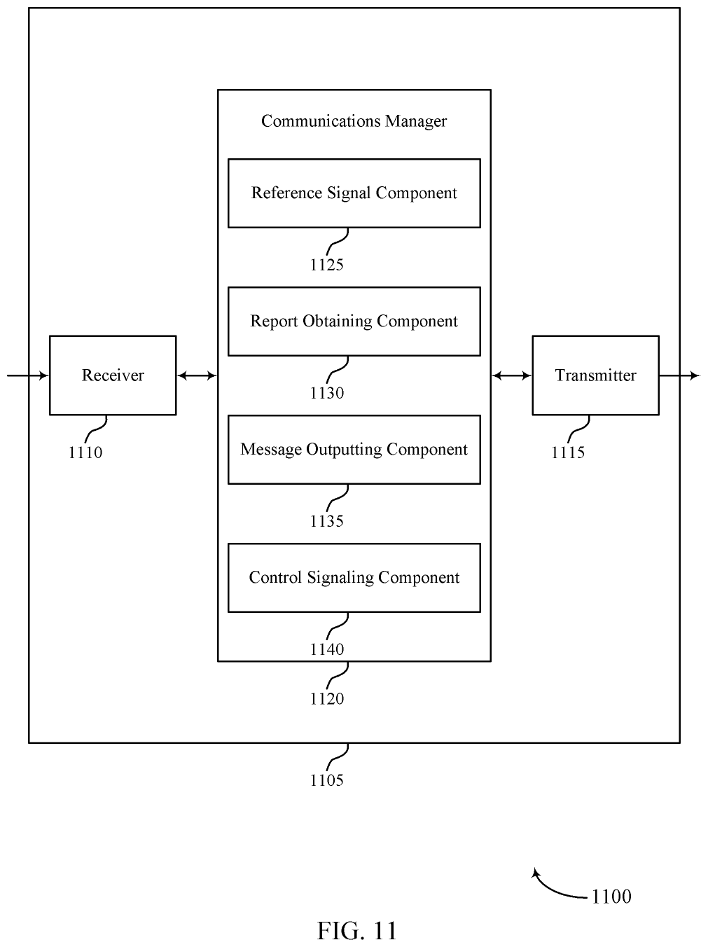

FIG. 11 shows a block diagram 1100 of a device 1105 that supports techniques for reporting QCL information in accordance with one or more aspects of the present disclosure. The device 1105 may be an example of aspects of a device 1005 or a network entity 105, as described herein. The device 1105 may include a receiver 1110, a transmitter 1115, and a communications manager 1120. The device 1105 may also include a processor (not shown). Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas (e.g., an antenna 1315 described herein with reference to FIG. 13). Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas (e.g., an antenna 1315 described herein with reference to FIG. 13). Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for reporting QCL information as described herein. For example, the communications manager 1120 may include a reference signal component 1125, a report obtaining component 1130, a message outputting component 1135, a control signaling component 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at the device 1105 in accordance with examples disclosed herein. The reference signal component 1125 may be configured as or otherwise support a means for outputting one or more reference signals via a reference signal resource set. The report obtaining component 1130 may be configured as or otherwise support a means for obtaining a report that indicates a downlink precoding matrix and a reference signal resource associated with QCL information used to determine the downlink precoding matrix, where the downlink precoding matrix includes a combination of reference signal resources from the reference signal resource set. The message outputting component 1135 may be configured as or otherwise support a means for outputting one or more downlink messages using the downlink precoding matrix indicated by the report.

Additionally, or alternatively, the communications manager 1120 may support wireless communication at the device 1105 in accordance with examples disclosed herein. The control signaling component 1140 may be configured as or otherwise support a means for outputting control signaling indicating QCL information associated with a reference signal resource. The reference signal component 1125 may be configured as or otherwise support a means for outputting one or more reference signals via a reference signal resource set. The report obtaining component 1130 may be configured as or otherwise support a means for obtaining an indication of a downlink precoding matrix that is based on the QCL information, where the downlink precoding matrix includes a combination of reference signal resources from the reference signal resource set. The message outputting component 1135 may be configured as or otherwise support a means for outputting one or more downlink messages using the downlink precoding matrix.

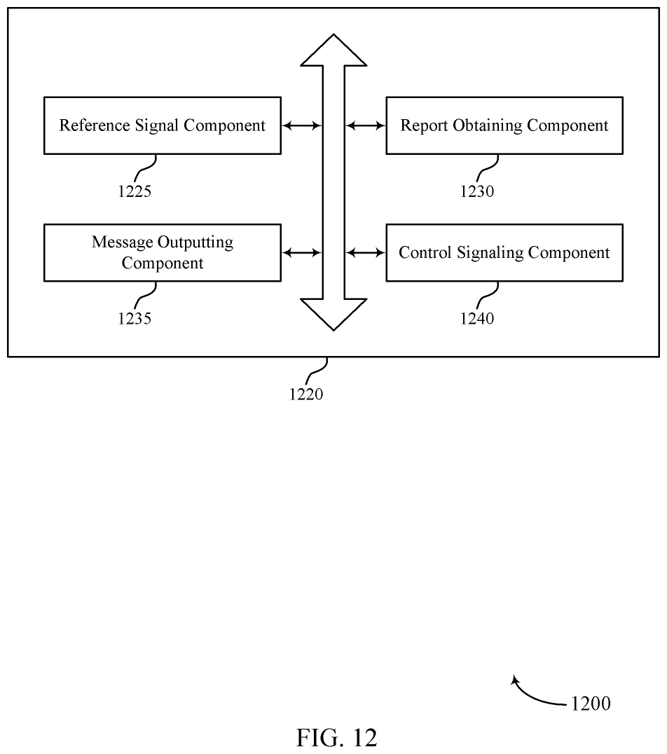

FIG. 12 shows a block diagram 1200 of a communications manager 1220 that supports techniques for reporting QCL information in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for reporting QCL information as described herein. For example, the communications manager 1220 may include a reference signal component 1225, a report obtaining component 1230, a message outputting component 1235, a control signaling component 1240, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples disclosed herein. The reference signal component 1225 may be configured as or otherwise support a means for outputting one or more reference signals via a reference signal resource set. The report obtaining component 1230 may be configured as or otherwise support a means for obtaining a report that indicates a downlink precoding matrix and a reference signal resource associated with QCL information used to determine the downlink precoding matrix, where the downlink precoding matrix includes a combination of reference signal resources from the reference signal resource set. The message outputting component 1235 may be configured as or otherwise support a means for outputting one or more downlink messages using the downlink precoding matrix indicated by the report.

Additionally, or alternatively, the communications manager 1220 may support wireless communication at a network entity in accordance with examples disclosed herein. The control signaling component 1240 may be configured as or otherwise support a means for outputting control signaling indicating QCL information associated with a reference signal resource. In some examples, the reference signal component 1225 may be configured as or otherwise support a means for outputting one or more reference signals via a reference signal resource set. In some examples, the report obtaining component 1230 may be configured as or otherwise support a means for obtaining an indication of a downlink precoding matrix that is based on the QCL information, where the downlink precoding matrix includes a combination of reference signal resources from the reference signal resource set. In some examples, the message outputting component 1235 may be configured as or otherwise support a means for outputting one or more downlink messages using the downlink precoding matrix.

FIG. 13 shows a diagram of a system 1300 including a device 1305 that supports techniques for reporting QCL information in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting techniques for reporting QCL information). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at the device 1305 in accordance with examples disclosed herein. For example, the communications manager 1320 may be configured as or otherwise support a means for outputting one or more reference signals via a reference signal resource set. The communications manager 1320 may be configured as or otherwise support a means for obtaining a report that indicates a downlink precoding matrix and a reference signal resource associated with QCL information used to determine the downlink precoding matrix, where the downlink precoding matrix includes a combination of reference signal resources from the reference signal resource set. The communications manager 1320 may be configured as or otherwise support a means for outputting one or more downlink messages using the downlink precoding matrix indicated by the report.

Additionally, or alternatively, the communications manager 1320 may support wireless communication at the device 1305 in accordance with examples disclosed herein. For example, the communications manager 1320 may be configured as or otherwise support a means for outputting control signaling indicating QCL information associated with a reference signal resource. The communications manager 1320 may be configured as or otherwise support a means for outputting one or more reference signals via a reference signal resource set. The communications manager 1320 may be configured as or otherwise support a means for obtaining an indication of a downlink precoding matrix that is based on the QCL information, where the downlink precoding matrix includes a combination of reference signal resources from the reference signal resource set. The communications manager 1320 may be configured as or otherwise support a means for outputting one or more downlink messages using the downlink precoding matrix.

By including or configuring the communications manager 1320 in accordance with examples as described herein, the device 1305 may support techniques for improved communication reliability and lower resource overhead. For example, the device 1305 may provide a UE with QCL information to use for downlink precoding, which may enable the UE to calculate downlink precoding information with greater accuracy. For example, the UE may use the QCL information provided by the device 1305 to determine an implicit downlink PMI for subsequent communications with the device 1305. Thus, configuring the UE with QCL information in accordance with examples described herein may improve the likelihood of successful downlink communications between the UE and the device 1305.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described herein with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of techniques for reporting QCL information as described herein, or the processor 1335 and the memory 1325 may be otherwise configured to perform or support such operations.

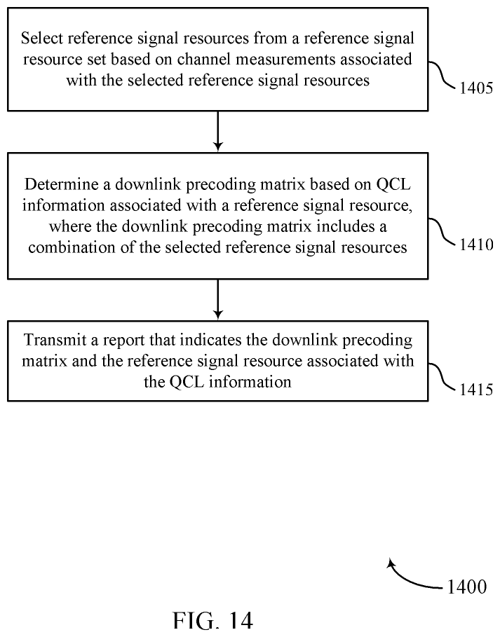

FIG. 14 shows a flowchart illustrating a method 1400 that supports techniques for reporting QCL information in accordance with one or more aspects of the present disclosure. The operations of the method 1400 may be implemented by a UE or components of a UE, as described herein. For example, the operations of the method 1400 may be performed by a UE 115, as described herein with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include selecting reference signal resources from a reference signal resource set based on channel measurements associated with the selected reference signal resources. The operations of 1405 may be performed in accordance with examples disclosed herein. In some examples, aspects of the operations of 1405 may be performed by a resource selecting component 825, as described herein with reference to FIG. 8.

At 1410, the method may include determining a downlink precoding matrix based on QCL information associated with a reference signal resource, where the downlink precoding matrix includes a combination of the selected reference signal resources. The operations of 1410 may be performed in accordance with examples disclosed herein. In some examples, aspects of the operations of 1410 may be performed by a matrix determining component 830, as described herein with reference to FIG. 8.

At 1415, the method may include transmitting a report that indicates the downlink precoding matrix and the reference signal resource associated with the QCL information. The operations of 1415 may be performed in accordance with examples disclosed herein. In some examples, aspects of the operations of 1415 may be performed by a report transmitting component 835, as described herein with reference to FIG. 8.

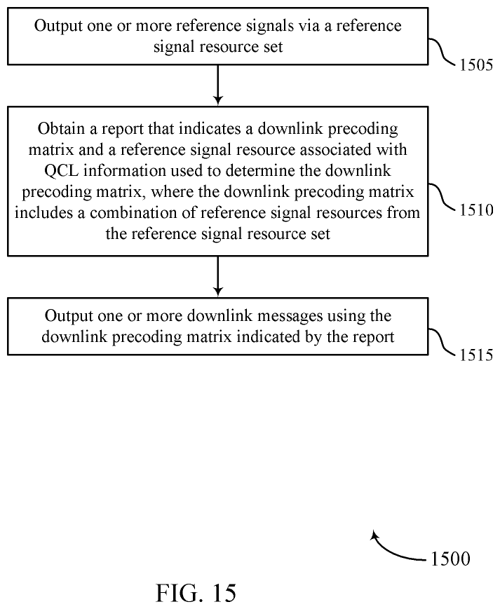

FIG. 15 shows a flowchart illustrating a method 1500 that supports techniques for reporting QCL information in accordance with one or more aspects of the present disclosure. The operations of the method 1500 may be implemented by a network entity or components of a network entity, as described herein. For example, the operations of the method 1500 may be performed by a network entity 105, as described herein with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include outputting one or more reference signals via a reference signal resource set. The operations of 1505 may be performed in accordance with examples disclosed herein. In some examples, aspects of the operations of 1505 may be performed by a reference signal component 1225, as described herein with reference to FIG. 12.

At 1510, the method may include obtaining a report that indicates a downlink precoding matrix and a reference signal resource associated with QCL information used to determine the downlink precoding matrix, where the downlink precoding matrix includes a combination of reference signal resources from the reference signal resource set. The operations of 1510 may be performed in accordance with examples disclosed herein. In some examples, aspects of the operations of 1510 may be performed by a report obtaining component 1230, as described herein with reference to FIG. 12.

At 1515, the method may include outputting one or more downlink messages using the downlink precoding matrix indicated by the report. The operations of 1515 may be performed in accordance with examples disclosed herein. In some examples, aspects of the operations of 1515 may be performed by a message outputting component 1235, as described herein with reference to FIG. 12.

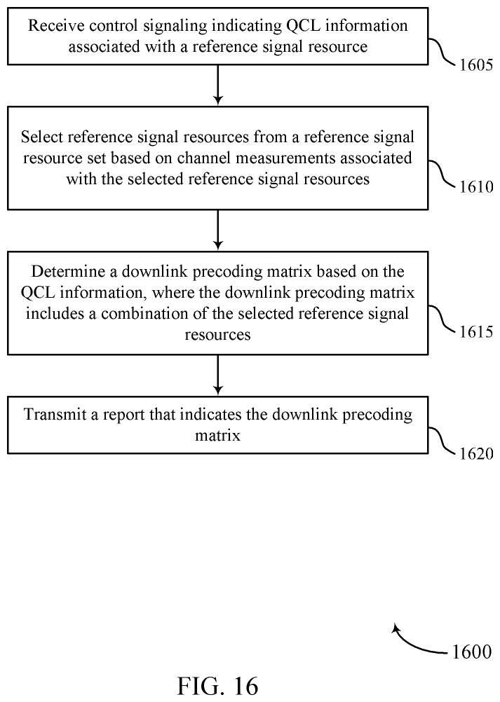

FIG. 16 shows a flowchart illustrating a method 1600 that supports techniques for reporting QCL information in accordance with one or more aspects of the present disclosure. The operations of the method 1600 may be implemented by a UE or components of a UE, as described herein. For example, the operations of the method 1600 may be performed by a UE 115, as described herein with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving control signaling indicating QCL information associated with a reference signal resource. The operations of 1605 may be performed in accordance with examples disclosed herein. In some examples, aspects of the operations of 1605 may be performed by a control signaling receiver 840, as described herein with reference to FIG. 8.

At 1610, the method may include selecting reference signal resources from a reference signal resource set based on channel measurements associated with the selected reference signal resources. The operations of 1610 may be performed in accordance with examples disclosed herein. In some examples, aspects of the operations of 1610 may be performed by a resource selecting component 825, as described herein with reference to FIG. 8.

At 1615, the method may include determining a downlink precoding matrix based on the QCL information, where the downlink precoding matrix includes a combination of the selected reference signal resources. The operations of 1615 may be performed in accordance with examples disclosed herein. In some examples, aspects of the operations of 1615 may be performed by a matrix determining component 830, as described herein with reference to FIG. 8.

At 1620, the method may include transmitting a report that indicates the downlink precoding matrix. The operations of 1620 may be performed in accordance with examples disclosed herein. In some examples, aspects of the operations of 1620 may be performed by a report transmitting component 835, as described herein with reference to FIG. 8.

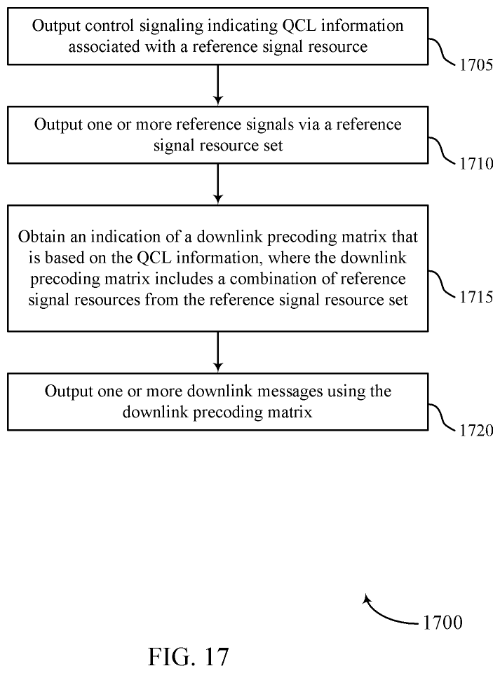

FIG. 17 shows a flowchart illustrating a method 1700 that supports techniques for reporting QCL information in accordance with one or more aspects of the present disclosure. The operations of the method 1700 may be implemented by a network entity or components of a network entity, as described herein. For example, the operations of the method 1700 may be performed by a network entity 105, as described herein with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include outputting control signaling indicating QCL information associated with a reference signal resource. The operations of 1705 may be performed in accordance with examples disclosed herein. In some examples, aspects of the operations of 1705 may be performed by a control signaling component 1240, as described herein with reference to FIG. 12.

At 1710, the method may include outputting one or more reference signals via a reference signal resource set. The operations of 1710 may be performed in accordance with examples disclosed herein. In some examples, aspects of the operations of 1710 may be performed by a reference signal component 1225, as described herein with reference to FIG. 12.

At 1715, the method may include obtaining an indication of a downlink precoding matrix that is based on the QCL information, where the downlink precoding matrix includes a combination of reference signal resources from the reference signal resource set. The operations of 1715 may be performed in accordance with examples disclosed herein. In some examples, aspects of the operations of 1715 may be performed by a report obtaining component 1230, as described herein with reference to FIG. 12.

At 1720, the method may include outputting one or more downlink messages using the downlink precoding matrix. The operations of 1720 may be performed in accordance with examples disclosed herein. In some examples, aspects of the operations of 1720 may be performed by a message outputting component 1235, as described herein with reference to FIG. 12.

The following provides an overview of aspects of the present disclosure:
Aspect 1: A method for wireless communication at a UE, comprising: selecting reference signal resources from a reference signal resource set based at least in part on channel measurements associated with the selected reference signal resources: determining a downlink precoding matrix based at least in part on quasi-co-location information associated with a reference signal resource, wherein the downlink precoding matrix comprises a combination of the selected reference signal resources; and transmitting a report that indicates the downlink precoding matrix and the reference signal resource associated with the quasi-co-location information.
Aspect 2: The method of aspect 1, wherein the reference signal resource associated with the quasi-co-location information is included in the reference signal resource set.
Aspect 3: The method of aspect 1, wherein the reference signal resource associated with the quasi-co-location information is different from reference signal resources in the reference signal resource set.
Aspect 4: The method of aspect 3, further comprising: receiving control signaling indicating one or more reference signal resources that can be used to determine the downlink precoding matrix, wherein the one or more reference signal resources comprise the reference signal resource associated with the quasi-co-location information.
Aspect 5: The method of any of aspects 1 through 4, wherein transmitting the report comprises: transmitting a channel state information report that indicates the selected reference signal resources, a set of linear combination coefficients associated with the selected reference signal resources, a reference signal received power associated with the downlink precoding matrix, a signal to interference and noise ratio associated with the downlink precoding matrix, or any combination thereof.
Aspect 6: The method of any of aspects 1 through 5, wherein the selected reference signal resources comprise the reference signal resource associated with the quasi-co-location information.
Aspect 7: The method of any of aspects 1 through 6, wherein the reference signal resource associated with the quasi-co-location information comprises a reference signal resource with a highest reference signal received power or a highest signal to interference and noise ratio in the selected reference signal resources.
Aspect 8: The method of any of aspects 1 through 7, further comprising: identifying a quasi-co-location relationship between one of the selected reference signal resources and the reference signal resource associated with the quasi-co-location information.
Aspect 9: The method of any of aspects 1 through 8, further comprising: identifying a quasi-co-location relationship between the reference signal resource associated with the quasi-co-location information and a reference signal resource having a highest reference signal received power or a highest signal to interference and noise ratio in the selected reference signal resources.
Aspect 10: The method of any of aspects 1 through 9, wherein selecting the reference signal resources comprises: selecting channel state information reference signal resources from a channel state information reference signal resource set; and selecting channel state information reference signal ports for the selected channel state information reference signal resources.
Aspect 11: The method of aspect 10, wherein transmitting the report comprises: transmitting a channel state information report that indicates the selected channel state information reference signal resources, the selected channel state information reference signal ports, a set of quantized linear combination coefficients associated with the selected channel state information reference signal resources and the selected channel state information reference signal ports, or any combination thereof.
Aspect 12: The method of any of aspects 10 through 11, wherein the reference signal resource associated with the quasi-co-location information comprises a channel state information reference signal resource from the selected channel state information reference signal resources or a channel state information reference signal resource that is quasi-co-located with at least one of the selected channel state information reference signal resources.
Aspect 13: The method of any of aspects 10 through 12, wherein the reference signal resource associated with the quasi-co-location information comprises a channel state information reference signal resource with a highest reference signal received power or a highest signal to interference and noise ratio in the selected channel state information reference signal resources.
Aspect 14: The method of any of aspects 10 through 13, wherein the reference signal resource associated with the quasi-co-location information comprises a multi-port channel state information reference signal resource with a highest reference signal received power or a highest signal to interference and noise ratio in the selected channel state information reference signal resources; and the highest reference signal received power corresponds to an average reference signal received power across channel state information reference signal ports associated with the multi-port channel state information reference signal resource or a total reference signal received power across channel state information reference signal ports associated with the multi-port channel state information reference signal resource.
Aspect 15: The method of any of aspects 10 through 14, further comprising: identifying a quasi-co-location relationship between the reference signal resource associated with the quasi-co-location information and a channel state information reference signal resource having a highest reference signal received power or a highest signal to interference and noise ratio in the selected channel state information reference signal resources.
Aspect 16: The method of any of aspects 1 through 15, further comprising: determining a beam point direction for downlink precoding based at least in part on channel measurements associated with the reference signal resource set, wherein the determined beam point direction is defined by an azimuth angle and an elevation angle.
Aspect 17: The method of aspect 16, wherein transmitting the report comprises: transmitting a channel state information report that indicates the determined beam point direction, a reference signal received power associated with the determined beam point direction, a signal to interference and noise ratio associated with the determined beam point direction, or any combination thereof.
Aspect 18: The method of any of aspects 16 through 17, further comprising: receiving an indication of a mapping between beam point directions and reference signal resources in the reference signal resource set; and selecting a reference signal resource from the reference signal resource set based at least in part on a beam point direction of the selected reference signal resource having a closest proximity to the determined beam point direction, wherein the reference signal resource associated with the quasi-co-location information comprises the selected reference signal resource.
Aspect 19: The method of any of aspects 16 through 18, further comprising: receiving an indication of a mapping between beam point directions and reference signal resources in the reference signal resource set: identifying two or more reference signal resources in the reference signal resource set that satisfy a proximity threshold with respect to the determined beam point direction; and selecting a reference signal resource from the identified two or more reference signal resources based at least in part on a reference signal resource identifier associated with the selected reference signal resource, an azimuth angle proximity of the selected reference signal resource, an elevation angle proximity of the selected reference signal resource, or any combination thereof, wherein the reference signal resource associated with the quasi-co-location information comprises the selected reference signal resource.
Aspect 20: The method of any of aspects 16 through 18, further comprising: receiving control signaling indicating a mapping between beam point directions and a set of downlink reference signal resources that are different from reference signal resources in the reference signal resource set; and selecting a downlink reference signal resource from the set of downlink reference signal resources based at least in part on a beam point direction of the selected downlink reference signal resource having a closest proximity to the determined beam point direction, wherein the reference signal resource associated with the quasi-co-location information comprises the selected downlink reference signal resource.
Aspect 21: The method of any of aspects 16 through 18, further comprising: receiving control signaling indicating a mapping between beam point directions and a set of downlink reference signal resources that are different from reference signal resources in the reference signal resource set: identifying two or more downlink reference signal resources in the set of downlink reference signal resources that satisfy a proximity threshold with respect to the determined beam point direction: prioritizing the two or more downlink reference signal resources with respect to resource type, resource identifier, azimuth angle proximity, elevation angle proximity, or any combination thereof; and selecting a downlink reference signal resource from the prioritized two or more downlink reference signal resources, wherein the reference signal resource associated with the quasi-co-location information comprises the selected downlink reference signal resource.
Aspect 22: A method for wireless communication at a network entity, comprising: outputting one or more reference signals via a reference signal resource set; obtaining a report that indicates a downlink precoding matrix and a reference signal resource associated with quasi-co-location information used to determine the downlink precoding matrix, wherein the downlink precoding matrix comprises a combination of reference signal resources from the reference signal resource set; and outputting one or more downlink messages using the downlink precoding matrix indicated by the report.
Aspect 23: A method for wireless communication at a UE, comprising: receiving control signaling indicating quasi-co-location information associated with a reference signal resource: selecting reference signal resources from a reference signal resource set based at least in part on channel measurements associated with the selected reference signal resources: determining a downlink precoding matrix based at least in part on the quasi-co-location information, wherein the downlink precoding matrix comprises a combination of the selected reference signal resources; and transmitting a report that indicates the downlink precoding matrix.
Aspect 24: The method of aspect 23, wherein receiving the control signaling comprises: receiving downlink control information that indicates a channel state information triggering state identifier associated with the reference signal resource to use for the quasi-co-location information.
Aspect 25: The method of any of aspects 23 through 24, wherein transmitting the report comprises: transmitting a channel state information report that indicates the selected reference signal resources, quantized linear combination coefficients associated with the selected reference signal resources, a reference signal received power associated with the downlink precoding matrix, a signal to interference and noise ratio associated with the downlink precoding matrix, or any combination thereof.
Aspect 26: The method of any of aspects 23 through 25, wherein selecting the reference signal resources comprises: selecting channel state information reference signal resources from a channel state information reference signal resource set; and selecting channel state information reference signal ports for the selected channel state information reference signal resources.
Aspect 27: The method of aspect 26, wherein transmitting the report comprises: transmitting a channel state information report that indicates the selected channel state information reference signal resources, the selected channel state information reference signal ports, a set of quantized linear combination coefficients associated with the selected channel state information reference signal resources and the selected channel state information reference signal ports, a reference signal received power associated with the downlink precoding matrix, a signal to interference and noise ratio associated with the downlink precoding matrix, or any combination thereof.
Aspect 28: The method of any of aspects 23 through 27, further comprising: determining a beam point direction for downlink precoding based at least in part on channel measurements associated with the reference signal resource set, wherein the determined beam point direction is defined by an azimuth angle and an elevation angle.
Aspect 29: The method of aspect 28, wherein transmitting the report comprises: transmitting a channel state information report that indicates the determined beam point direction, a reference signal received power associated with the determined beam point direction, a signal to interference and noise ratio associated with the determined beam point direction, or any combination thereof.
Aspect 30: A method for wireless communication at a network entity, comprising: outputting control signaling indicating quasi-co-location information associated with a reference signal resource: outputting one or more reference signals via a reference signal resource set: obtaining an indication of a downlink precoding matrix that is based at least in part on the quasi-co-location information, wherein the downlink precoding matrix comprises a combination of reference signal resources from the reference signal resource set; and outputting one or more downlink messages using the downlink precoding matrix.
Aspect 31: An apparatus for wireless communication at a UE, comprising a processor and a memory coupled with the processor, with instructions stored in the memory, the instructions being executable by the processor to cause the apparatus to perform a method of any of aspects 1 through 21.
Aspect 32: An apparatus for wireless communication at a UE, comprising at least one means for performing a method of any of aspects 1 through 21.
Aspect 33: A non-transitory computer-readable medium storing code for wireless communication at a UE, the code comprising instructions executable by a processor to perform a method of any of aspects 1 through 21.
Aspect 34: An apparatus for wireless communication at a network entity, comprising a processor and a memory coupled with the processor, with instructions stored in the memory, the instructions being executable by the processor to cause the apparatus to perform the method of aspect 22.
Aspect 35: An apparatus for wireless communication at a network entity, comprising at least one means for performing the method of aspect 22.
Aspect 36: A non-transitory computer-readable medium storing code for wireless communication at a network entity, the code comprising instructions executable by a processor to perform the method of aspect 22.
Aspect 37: An apparatus for wireless communication at a UE, comprising a processor and a memory coupled with the processor, with instructions stored in the memory, the instructions being executable by the processor to cause the apparatus to perform a method of any of aspects 23 through 29.
Aspect 38: An apparatus for wireless communication at a UE, comprising at least one means for performing a method of any of aspects 23 through 29.
Aspect 39: A non-transitory computer-readable medium storing code for wireless communication at a UE, the code comprising instructions executable by a processor to perform a method of any of aspects 23 through 29.
Aspect 40: An apparatus for wireless communication at a network entity, comprising a processor and a memory coupled with the processor, with instructions stored in the memory, the instructions being executable by the processor to cause the apparatus to perform the method of aspect 30.
Aspect 41: An apparatus for wireless communication at a network entity, comprising at least one means for performing the method of aspect 30.
Aspect 42: A non-transitory computer-readable medium storing code for wireless communication at a network entity, the code comprising instructions executable by a processor to perform the method of aspect 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
selecting reference signal resources from a reference signal resource set based at least in part on channel measurements associated with the selected reference signal resources;
determining a downlink precoding matrix based at least in part on quasi-co-location information associated with a reference signal resource, wherein the downlink precoding matrix comprises a combination of the selected reference signal resources; and
transmitting a report that indicates the downlink precoding matrix and the reference signal resource associated with the quasi-co-location information.

2. The method of claim 1, wherein the reference signal resource associated with the quasi-co-location information is included in the reference signal resource set.

3. The method of claim 1, wherein the reference signal resource associated with the quasi-co-location information is different from reference signal resources in the reference signal resource set.

4. The method of claim 3, further comprising:
receiving control signaling indicating one or more reference signal resources that can be used to determine the downlink precoding matrix, wherein the one or more reference signal resources comprise the reference signal resource associated with the quasi-co-location information.

5. The method of claim 1, wherein transmitting the report comprises:
transmitting a channel state information report that indicates the selected reference signal resources, a set of linear combination coefficients associated with the selected reference signal resources, a reference signal received power associated with the downlink precoding matrix, a signal to interference and noise ratio associated with the downlink precoding matrix, or any combination thereof.

6. The method of claim 1, wherein the selected reference signal resources comprise the reference signal resource associated with the quasi-co-location information.

7. The method of claim 1, wherein the reference signal resource associated with the quasi-co-location information comprises a reference signal resource with a highest reference signal received power or a highest signal to interference and noise ratio in the selected reference signal resources.

8. The method of claim 1, further comprising:
identifying a quasi-co-location relationship between one of the selected reference signal resources and the reference signal resource associated with the quasi-co-location information.

9. The method of claim 1, further comprising:
identifying a quasi-co-location relationship between the reference signal resource associated with the quasi-co-location information and a reference signal resource having a highest reference signal received power or a highest signal to interference and noise ratio in the selected reference signal resources.

10. The method of claim 1, wherein selecting the reference signal resources comprises:
selecting channel state information reference signal resources from a channel state information reference signal resource set; and
selecting channel state information reference signal ports for the selected channel state information reference signal resources.

11. The method of claim 10, wherein transmitting the report comprises:
transmitting a channel state information report that indicates the selected channel state information reference signal resources, the selected channel state information reference signal ports, a set of quantized linear combination coefficients associated with the selected channel state information reference signal resources and the selected channel state information reference signal ports, or any combination thereof.

12. The method of claim 10, wherein the reference signal resource associated with the quasi-co-location information comprises a channel state information reference signal resource from the selected channel state information reference signal resources or a channel state information reference signal resource that is quasi-co-located with at least one of the selected channel state information reference signal resources.

13. The method of claim 10, wherein the reference signal resource associated with the quasi-co-location information comprises a channel state information reference signal resource with a highest reference signal received power or a highest signal to interference and noise ratio in the selected channel state information reference signal resources.

14. The method of claim 10, wherein:
the reference signal resource associated with the quasi-co-location information comprises a multi-port channel state information reference signal resource with a highest reference signal received power or a highest signal to interference and noise ratio in the selected channel state information reference signal resources; and
the highest reference signal received power corresponds to an average reference signal received power across channel state information reference signal ports associated with the multi-port channel state information reference signal resource or a total reference signal received power across channel state information reference signal ports associated with the multi-port channel state information reference signal resource.

15. The method of claim 10, further comprising:
identifying a quasi-co-location relationship between the reference signal resource associated with the quasi-co-location information and a channel state information reference signal resource having a highest reference signal received power or a highest signal to interference and noise ratio in the selected channel state information reference signal resources.

16. The method of claim 1, further comprising:
determining a beam point direction for downlink precoding based at least in part on channel measurements associated with the reference signal resource set, wherein the determined beam point direction is defined by an azimuth angle and an elevation angle.

17. The method of claim 16, wherein transmitting the report comprises:
transmitting a channel state information report that indicates the determined beam point direction, a reference signal received power associated with the determined beam point direction, a signal to interference and noise ratio associated with the determined beam point direction, or any combination thereof.

18. The method of claim 16, further comprising:
receiving an indication of a mapping between beam point directions and reference signal resources in the reference signal resource set; and
selecting a reference signal resource from the reference signal resource set based at least in part on a beam point direction of the selected reference signal resource having a closest proximity to the determined beam point direction, wherein the reference signal resource associated with the quasi-co-location information comprises the selected reference signal resource.

19. The method of claim 16, further comprising:
receiving an indication of a mapping between beam point directions and reference signal resources in the reference signal resource set;
identifying two or more reference signal resources in the reference signal resource set that satisfy a proximity threshold with respect to the determined beam point direction; and
selecting a reference signal resource from the identified two or more reference signal resources based at least in part on a reference signal resource identifier associated with the selected reference signal resource, an azimuth angle proximity of the selected reference signal resource, an elevation angle proximity of the selected reference signal resource, or any combination thereof, wherein the reference signal resource associated with the quasi-co-location information comprises the selected reference signal resource.

20. The method of claim 16, further comprising:
receiving control signaling indicating a mapping between beam point directions and a set of downlink reference signal resources that are different from reference signal resources in the reference signal resource set; and
selecting a downlink reference signal resource from the set of downlink reference signal resources based at least in part on a beam point direction of the selected downlink reference signal resource having a closest proximity to the determined beam point direction, wherein the reference signal resource associated with the quasi-co-location information comprises the selected downlink reference signal resource.

21. The method of claim 16, further comprising:
receiving control signaling indicating a mapping between beam point directions and a set of downlink reference signal resources that are different from reference signal resources in the reference signal resource set;
identifying two or more downlink reference signal resources in the set of downlink reference signal resources that satisfy a proximity threshold with respect to the determined beam point direction;
prioritizing the two or more downlink reference signal resources with respect to resource type, resource identifier, azimuth angle proximity, elevation angle proximity, or any combination thereof; and
selecting a downlink reference signal resource from the prioritized two or more downlink reference signal resources, wherein the reference signal resource associated with the quasi-co-location information comprises the selected downlink reference signal resource.

22. A method for wireless communication at a network entity, comprising:
outputting one or more reference signals via a reference signal resource set;
obtaining a report that indicates a downlink precoding matrix and a reference signal resource associated with quasi-co-location information used to determine the downlink precoding matrix, wherein the downlink precoding matrix comprises a combination of reference signal resources from the reference signal resource set; and
outputting one or more downlink messages using the downlink precoding matrix indicated by the report.

23. A method for wireless communication at a user equipment (UE), comprising:
receiving control signaling indicating quasi-co-location information associated with a reference signal resource;
selecting reference signal resources from a reference signal resource set based at least in part on channel measurements associated with the selected reference signal resources;
determining a downlink precoding matrix based at least in part on the quasi-co-location information, wherein the downlink precoding matrix comprises a combination of the selected reference signal resources; and
transmitting a report that indicates the downlink precoding matrix.

24. The method of claim 23, wherein receiving the control signaling comprises:
receiving downlink control information that indicates a channel state information triggering state identifier associated with the reference signal resource to use for the quasi-co-location information.

25. The method of claim 23, wherein transmitting the report comprises:
transmitting a channel state information report that indicates the selected reference signal resources, quantized linear combination coefficients associated with the selected reference signal resources, a reference signal received power associated with the downlink precoding matrix, a signal to interference and noise ratio associated with the downlink precoding matrix, or any combination thereof.

26. The method of claim 23, wherein selecting the reference signal resources comprises:
selecting channel state information reference signal resources from a channel state information reference signal resource set; and
selecting channel state information reference signal ports for the selected channel state information reference signal resources.

27. The method of claim 26, wherein transmitting the report comprises:
transmitting a channel state information report that indicates the selected channel state information reference signal resources, the selected channel state information reference signal ports, a set of quantized linear combination coefficients associated with the selected channel state information reference signal resources and the selected channel state information reference signal ports, a reference signal received power associated with the downlink precoding matrix, a signal to interference and noise ratio associated with the downlink precoding matrix, or any combination thereof.

28. The method of claim 23, further comprising:
determining a beam point direction for downlink precoding based at least in part on channel measurements associated with the reference signal resource set, wherein the determined beam point direction is defined by an azimuth angle and an elevation angle.

29. The method of claim 28, wherein transmitting the report comprises:
transmitting a channel state information report that indicates the determined beam point direction, a reference signal received power associated with the determined beam point direction, a signal to interference and noise ratio associated with the determined beam point direction, or any combination thereof.

30. A method for wireless communication at a network entity, comprising:
outputting control signaling indicating quasi-co-location information associated with a reference signal resource;
outputting one or more reference signals via a reference signal resource set;
obtaining an indication of a downlink precoding matrix that is based at least in part on the quasi-co-location information, wherein the downlink precoding matrix comprises a combination of reference signal resources from the reference signal resource set; and
outputting one or more downlink messages using the downlink precoding matrix.
